(19) United States
(12) Patent Application Publication
(10) Pub. No.: US 2008/0201751 A1
(43) Pub. Date: Aug. 21, 2008

(54) Wireless Media Transmission Systems and Methods

(76) Inventors: Sherjil Ahmed, Irvine, CA (US); Mohammad Usman, Mission Viejo, CA (US); Abhishek Joshi, Irvine, CA (US); Mudeem Siddiqui, Irvine, CA (US); Patrick Rault, Irvine, CA (US); Malik Muhammad Saqib, Irvine, CA (US)

Correspondence Address: PATENTMETRIX, 14252 CULVER DR. BOX 914, IRVINE, CA, 92604, US

(21) Appl. No.: 11/875,592

(22) Filed: Oct. 19, 2007

Related U.S. Application Data
(63) Continuation-in-part of application No. 11/911,785.
(60) Provisional application No. 60/862,069, filed on Oct. 19, 2006.
(60) Provisional application No. 60/955,740, filed on Aug. 14, 2007.

(51) Int. Cl. H04N 7/173

(52) U.S. Cl. 725/109

(57) ABSTRACT

The present invention relates to a media transmission and reception system that is implemented, in the form of programs stored in a satellite device having a memory, an input mechanism for receiving commands from a user, and a transceiver capable of wirelessly accessing a network, and in a computing device having a memory and a transceiver capable of accessing a network. The program stored in the memory of the satellite device causes user commands to be processed, causes the satellite device to connect to the computing device through the network, and causes the satellite device to transmit command instructions, derived from the commands, to the computing device through the network. The program stored in the memory of the computing device causes the computing device to access media stored in a memory, causes the computing device to process the media, captures the processed media, compresses the media, and causes the computing device to transmit the compressed media to the satellite device. The media access, media processing, media compression, and media transmission occurs in real-time and in response to the command instructions.

### CROSS-REFERENCE TO RELATED APPLICATIONS

The present application is a continuation-in-part of U.S. patent application Ser. No. 11/911,785, which is a U.S. National Stage Application under 35 USC Section 371 of PCT/U506/14559, and further calls priority to U.S. Provisional Application Nos. 60/862,069 and 60/955,740, filed on Oct. 19, 2006 and Aug. 14, 2007, respectively.

### FIELD OF THE INVENTION

The present invention relates generally to novel methods systems, implemented using programmatic code in one or more hardware devices, for the wireless real time transmission of data from a remote source using the processing power of a networked computing device to a display, such as a display associated with a satellite device. The present invention also relates generally to methods and systems that enable the wireless real time transmission of data from a source under the control of a controller, that is physically remote from a source, to a display that is remote from both the source and controller. The present invention further relates generally to the substantially automatic configuration of wireless devices.

### BACKGROUND OF THE INVENTION

Individuals use their computing devices, including personal computers, storage devices, mobile phones, personal data assistants, and servers, to store, record, transmit, receive, and playback media, including, but not limited to, graphics, text, video, images, and audio. Such media may be obtained from many sources, including, but not limited to, the Internet, CDs, DVDs, other networks, or other storage devices. In particular, individuals are able to rapidly and massively distribute and access media through open networks, often without time, geographic, cost, range of content or other restrictions. However, individuals are often forced to experience the obtained media on small screens that are not suitable for audiences in excess of one or two people.

Despite the rapid growth and flexibility of using computing devices to store, record, transmit, receive, and playback media, a vast majority of individuals throughout the world still use televisions as the primary means by which they receive audio/video transmissions. Specifically, over the air, satellite, and cable transmissions to televisions still represent the dominant means by which audio/video media is communicated to, and experienced by, individuals. Those transmissions, however, are highly restricted in terms of cost, range of content, access time and geography.

Given the ubiquity of individual computing devices being used to store, record, transmit, receive, and playback media, it would be preferred to be able to use those same computing devices, in conjunction with the vast installed base of televisions, to allow individuals to rapidly and flexibly obtain media and, yet, still use their televisions to experience the media. More generally, it would be preferred to use a central networked computing device, such as a personal computer, gaming console, or other computing device, to access network accessible content, process the content, and transmit the content for display and/or use on the screen of a satellite device, such as a display, television, camera, tablet PC, mobile phone, PDA, or other device.

Prior attempts at enabling the integration of computing devices with televisions have focused on a) transforming the television into a networked computing appliance that directly accesses the Internet to obtain media, b) creating a specialized hardware device that receives media from a computing device, stores it, and, through a wired connection, transfers it to the television, and/or c) integrating into the television a means to accept storage devices, such as memory sticks. However, these conventional approaches suffer from having to substantially modify existing equipment, i.e. replacing existing computing devices and/or televisions, or purchasing expensive new hardware. Additionally, these approaches have typically required the use of multiple physical hard-wired connections to transmit graphics, text, audio, and video. Such physical connections limit the use of devices to a single television, limit the placement of equipment to a particular area in the home, and result in an unsightly web of wires. Finally, the requirement to physically store media to a storage element, such as a memory stick, and then input into the television is not only cumbersome and inflexible, but highly limited in the amount of data that can be transferred.

In addition, wireless connections are often inconsistent and there is a need for a reliable connection so that the transmission of network accessible content to display is without interruption or delay. Further, different homes have different configuration of PCs, laptops, desktops, remote monitors, television sets, projectors, network, network cabling, which results in variety of compatibility problems while configuring. Furthermore, one cannot assume that the central network computing device, such as a PC/Laptop, is going to be in the same room as the display, as a TV; therefore, there is also a need for software which can configure devices even if they are at different premises. Moreover, users are generally reluctant to change their legacy configurations and they look for solutions which can conveniently use their existing devices with minor or no changes.

There is therefore still a need for methods, devices, and systems that enable individuals to use existing computing devices to receive, transmit, store, and playback media and to use existing televisions to experience the media. There is also a need for a simple, inexpensive way to wireless transmit media from a computing device to a television, thereby transforming the television in a remote monitor. It would also be preferred if numerous diverging standards applicable to text, graphics, video, audio transmission can be managed by a single, universal wireless media transmission system. Additionally, there is a need for convenient, automated configuration of wireless and wired devices.

Separately, there is a need to use the vast computer power of central networked computing devices to enable the distributed processing of media. In order to experience media, such as text, graphics, video, or audio, on a hand-held or mobile device, such as a mobile phone or personal data assistant, one must typically include a substantially complete processing system on the hand-held device that is capable of handling numerous different types of decoding requirements. It would be preferable, however, to use the existing processing power on a stationary computing device, such as a desk-top computer, server, set-top box, DVD player, or laptop computer, to process a media stream and then encode the substantially processed media stream for decoding on the hand-held device, also referred to herein as the satellite device. That way, the superior processing power of a desktop computer can be used to the benefit of satellite devices by processing numerous differently formatted and encoded media data streams and re-encoding those different processed streams into a media stream of a single format, which can then be readily received and decoded by the satellite device.

There is also a need to be able to separate control functionality, which guides the access, retrieval and processing of media streams, from display functionality. In common practice, any information obtained on a satellite or computing device is viewed on a display associated with the device itself. That is, the display has mainly been integrated into the satellite or computing device, which function as the controller of media streams.

However, for several applications, the display associated with a computing device does not provide the best means for viewing the information obtained on that computing device. For example, although mobile phones support functions such as viewing Internet pages and video conferencing, the display integrated with a cell phone is hardly suitable in terms of size and resolution to offer a good quality view of the content. Given the ubiquity of individual computing devices being used to store, record, transmit, receive, and playback media, it would be advantageous if the content obtained through these computing devices can be viewed on any suitable display medium, such as a monitor, a television set or a projector.

There is therefore a need for methods and systems that allow individuals to rapidly and flexibly obtain content using existing computing devices, and also allow experiencing or viewing the obtained content using any display medium. There is also a need for a simple, inexpensive method and system that enables wireless transmission of media not only from a computing device, but from any source of media to any output peripheral or display device. It would also be preferred that such a method and system for wireless media transmission is capable of managing numerous diverging standards applicable to text, graphics, video and audio transmission.

### SUMMARY OF THE INVENTION

The present invention relates to a media transmission and reception system that is implemented, in the form of provided programs stored in a satellite device having a memory, an input mechanism for receiving commands from a user, and a transceiver capable of wirelessly accessing an IP network, and in a computing device having a memory and a transceiver capable of accessing an IP network. In one embodiment, the programs comprise a plurality of routines stored in the memory of the satellite device wherein the routines, when executed by a processor of said satellite device, causes the commands to be processed, causes the satellite device to connect to the computing device through said IP network, and causes the satellite device to transmit command instructions, derived from the commands, to the computing device through the network and a plurality of routines stored in the memory of the computing device wherein the routines, when executed by a processor of said computing device, causes the computing device to access media stored in a memory, causes the computing device to process said media, captures the processed media, compresses the media, and causes the computing device to transmit the compressed media to the satellite device, wherein the media access, media process, media compression, and media transmission occurs in real-time and response to the command instructions.

The satellite device can be any hand-held device, such as a cellular phone, iPod, or MPEG player, or personal data assistant. The computing device can be any computer, including a personal computer, server, or laptop. The media can be located remote from, or local to, the computing device. Where it is remote from the computing device, the media is accessed by the computing device via the network.

The programs stored in the memory of the computing device can capture the processed media by capturing video data from a mirror display driver and by capturing audio data from an input source. Alternatively, the programs stored in the memory of the computing device may capture processed media by capturing video data from a buffer after video data has been processed and prior to processed video data being rendered to a display.

Optionally, the programs stored in the memory of the computing device encodes media after it media has been processed and captured and before the media is transmitted to the satellite device. The programs stored in the memory of the satellite device decode media after media has been received from said computing device.

In another embodiment, the present invention is a method of capturing media from a source and wirelessly transmitting said media, comprising the steps of: playing said media, comprising at least audio data and video data, on a computing device; capturing said video data using a mirror display driver; capturing said audio data from an input source; compressing said captured audio and video data; and transmitting said compressed audio and video data using a transmitter.

Optionally, the method and system further comprises the step of receiving said media at a receiver, decompressing said captured audio and video data, and playing said decompressed audio and video data on a display remote from said source. Optionally, the transmitter and receiver establish a connection using TCP and the transmitter transmits packets of video data using UDP.

Optionally, the method and system further comprises the step of processing video data using a CODEC. Optionally, the CODEC removes temporal redundancy from the video data using a motion estimation block. Optionally, the CODEC converts a frame of video data into x*y blocks where x equals y (e.g., 8*8 or 4*4 blocks) of pixels using a DCT transform block. Optionally, the CODEC codes video content into shorter words using a VLC coding circuit. Optionally, the CODEC converts back spatial frequencies of the video data into the pixel domain using an IDCT block. Optionally, the CODEC comprises a rate control mechanism for speeding up the transmission of media.

These, and other embodiments, will be described in greater clarity in the Detailed Description and with reference to a Brief Description of the Drawings.

### BRIEF DESCRIPTION OF THE DRAWINGS

These and other features and advantages of the present invention will be appreciated, as they become better understood by reference to the following Detailed Description when considered in connection with the accompanying drawings, wherein:

FIG. 1 depicts a block diagram of the communication between components of the integrated wireless media transmission system of the present invention;

FIG. 2 depicts the components of a transmitter of one embodiment of the present invention;

FIG. 3 depicts a plurality of software modules comprising one embodiment of a software implementation of the present invention;

FIG. 4 depicts the components of a receiver of one embodiment of the present invention;

FIG. 5 is a flowchart depicting an exemplary operation of the present invention;

FIG. 6 depicts one embodiment of the TCP/UDP RT hybrid protocol header structures of the present invention;

FIG. 7 is a flowchart depicting exemplary functional steps of the TCP/UDP RT transmission protocol of the present invention;

FIG. 8 depicts a block diagram of an exemplary codec used in the present invention;

FIG. 9 is a functional diagram of an exemplary motion estimation block used in the present invention;

FIG. 10 depicts one embodiment of the digital signal waveform and the corresponding data transfer;

FIG. 11 is a block diagram of an exemplary video processing and selective optimization of the IDCT block of the present invention;

FIG. 12 is a block diagram depicting the components of the synchronization circuit for synchronizing audio and video data of the present invention;

FIG. 13 is a flowchart depicting another embodiment of synchronizing audio and video signals of the present invention;

FIG. 14 depicts another embodiment of the audio and video synchronization circuit of the present invention;

FIG. 15 depicts an enterprise configuration for automatically downloading and updating the software of the present invention;

FIG. 16a is a schematic diagram depicting the communication between a transmitter and plurality of receivers;

FIGS. 16b-f depicts the various configurations in which PC, PC2TV and WAN Router are connected;

FIG. 16g depicts an exemplary flowchart for detection of PC2TV, connected to the WAN router, via PC;

FIG. 16h depicts an exemplary flowchart for detection of PC2TV, connected to the WAN router wirelessly, via PC;

FIG. 17 depicts a block diagram of a Microsoft Windows framework for developing display drivers;

FIG. 18 depicts a block diagram of an interaction between a GDI and a display driver;

FIG. 19 depicts a block diagram of a DirectDraw architecture;

FIG. 20a depicts an exemplary PC to TV icon;

FIGS. 20b-20f depicts a plurality of graphical user interfaces demonstrating the process of automatically checking for the presence of connection software and connected displays;

FIG. 21 is a flowchart depicting another method of capturing data from a PC for transmission to a television;

FIG. 22 depicts an exemplary device configuration;

FIG. 23 depicts another exemplary device configuration;

FIG. 24 is a diagram presenting the transmission and aggregation of data feeds;

FIGS. 25a-25h presents a set of graphical user interfaces demonstrating the application interface features an embodiment of the present application;

FIG. 26 is a block diagram illustrating one embodiment of the present invention in which control functionality is remote and separate from the media source and display;

FIG. 27 illustrates the major components of a controller device, as used in one embodiment of the present invention;

FIG. 28 illustrates an exemplary architecture for the integrated Media Processor chip that is used with the controller device of the present invention;

FIG. 29 illustrates another exemplary interface to a software embodiment of the present invention, including an interface for customizing the visual presentation to a specific satellite device; and

FIG. 30 illustrates several exemplary delivery models in which the display and control of media is presented in a satellite device, and is remote from the hardware device that processed the media to create the stream.

In the figures, the first digit of any three-digit number generally indicates the number of the figure in which the element first appears. Where four-digit reference numbers are used, the first two digits generally indicate the figure number.

### DETAILED DESCRIPTION

The present invention comprises methods and systems for transmitting media wirelessly from one device to another device in real time. The present invention will be described with reference to the aforementioned drawings. The embodiments described herein are not intended to be exhaustive or to limit the invention to the precise forms disclosed. They are chosen to explain the invention and its application and to enable others skilled in the art to utilize the invention. Unless expressly stated herein, no disclaimers of any embodiments are implied.

It should be appreciated that, where programmatic functions are described, including but not limited to transmission, reception, encoding, decoding, interfaces, and other processing steps, the programmatic functions are performed by a plurality of computing instructions, stored in memory, and executed by a hardware system that includes processing elements.

### Media Capture and Transmission

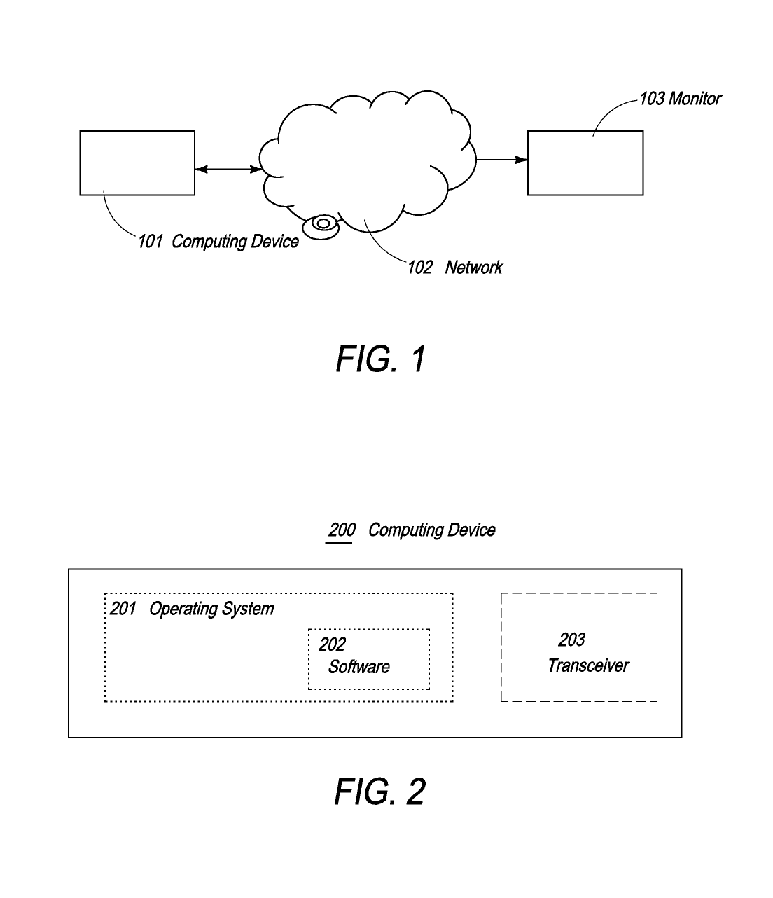

Referring to FIG. 1, a computing device 101, such as a conventional personal computer, desktop, laptop, PDA, mobile telephone, gaming station, set-top box, satellite receiver, DVD player, personal video recorder, or any other device, operating the novel systems of the present invention communicates through a wireless network 102 to a remote monitor 103. Preferably, the computing device 101 and remote monitor 103 further comprise a processing system on a chip capable of wirelessly transmitting and receiving data, graphics, audio, text, and video encoded under a plurality of standards, generally referred to as media. The remote monitor 103 can be a television, plasma display device, flat panel LCD, HDD, projector or any other electronic display device known in the art capable of rendering graphics, audio and video. The processing system on chip can either be integrated into the remote monitor 103 and computing device 101 or incorporated into a standalone device that is in wired or wireless communication with the remote monitor 103 or computing device 101. An exemplary processing system on a chip is described in PCT/US2006/00622, which is also assigned to the owner of the present application, and incorporated herein by reference.

Referring to FIG. 2, a computing device 200 of the present invention is depicted. Computing device 200 comprises an operating system 201 capable running the novel software systems of the present invention 202 and a transceiver 203. The operating system 201 can be any operating system including but not limited to Microsoft's Windows™ operating systems (2000, Windows NT™, XP™, Vista™), Linux™, IBM™ operating systems (OS/2™), Palm™-based operating systems, cell phone operating systems, iPod™ operating systems, and other Apple™ operating systems (MAC OS™). The computing device 200 transmits media using appropriate wireless standards for the transmission of graphics, text, video and audio signals, for example, IEEE 802.11a, 802.11g, Bluetooth2.0, HomeRF 2.0, HiperLAN/2, and Ultra Wideband, among others, along with proprietary extensions to any of these standards.

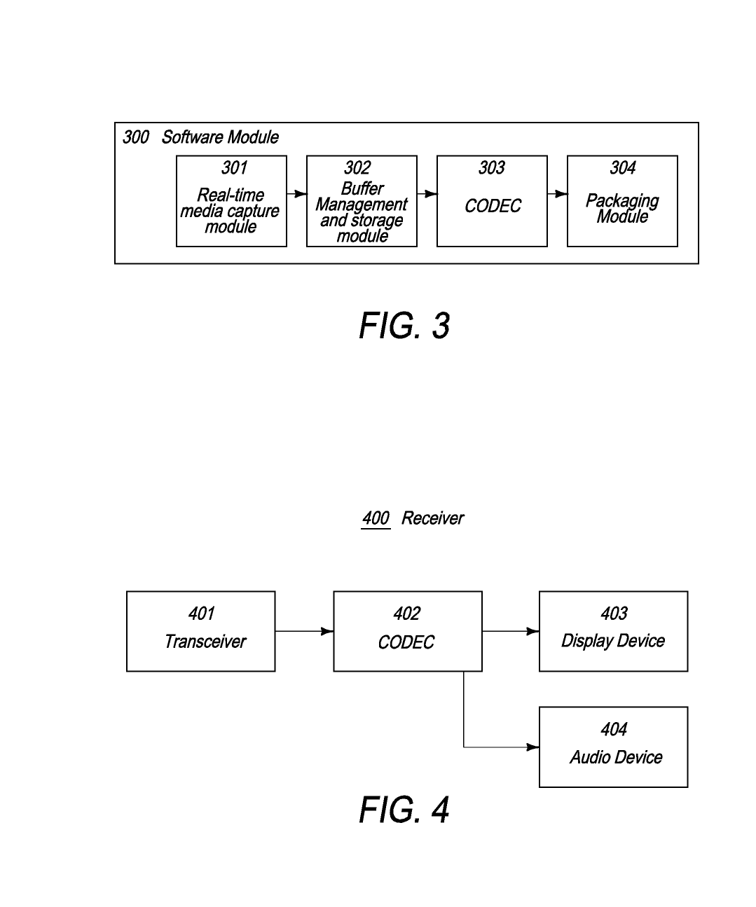

Referring to FIG. 3, modules of the novel software system 300 of the present invention is depicted. The software 300 comprises a module for the real-time capture of media 301, a module for managing a buffer for storing the captured media 302, a codec 303 for compressing and decompressing the media, and a module for packaging the processed media for transmission 304. In one embodiment, the computing device receives media from a source, whether it be downloaded from the Internet, real-time streamed from the Internet, transmitted from a cable or satellite station, transferred from a storage device, or any other source. The media is played on the computing device via suitable player installed on the computing device. While the media is played on the computing device, the software module 301 captures the data in real time and temporarily stores it in the buffer 302 before transmitting it to the CODEC. The CODEC 303 compresses it and prepares it for transmission.

Referring to FIG. 4, a receiver of the present invention is depicted. The receiver 400 comprises a transceiver 401, a CODEC 402, a display device 403 for rendering video and graphics data and an audio device 404 for rendering the audio data. The transceiver 401 receives the compressed media data, preferably through a novel transmission protocol used by the present invention. In one example, the novel transmission protocol is a TCP/UDP hybrid protocol. The TCP/UDP hybrid protocol for the real-time transmission of packets combines the security services of TCP with the simplicity and lower processing requirements of UDP. The content received by the receiver is then transmitted to the CODEC 402 for decompression. The CODEC decompresses the media and prepares the video and audio signals, which are then transmitted to the display device 403 and speakers 404 for rendering.

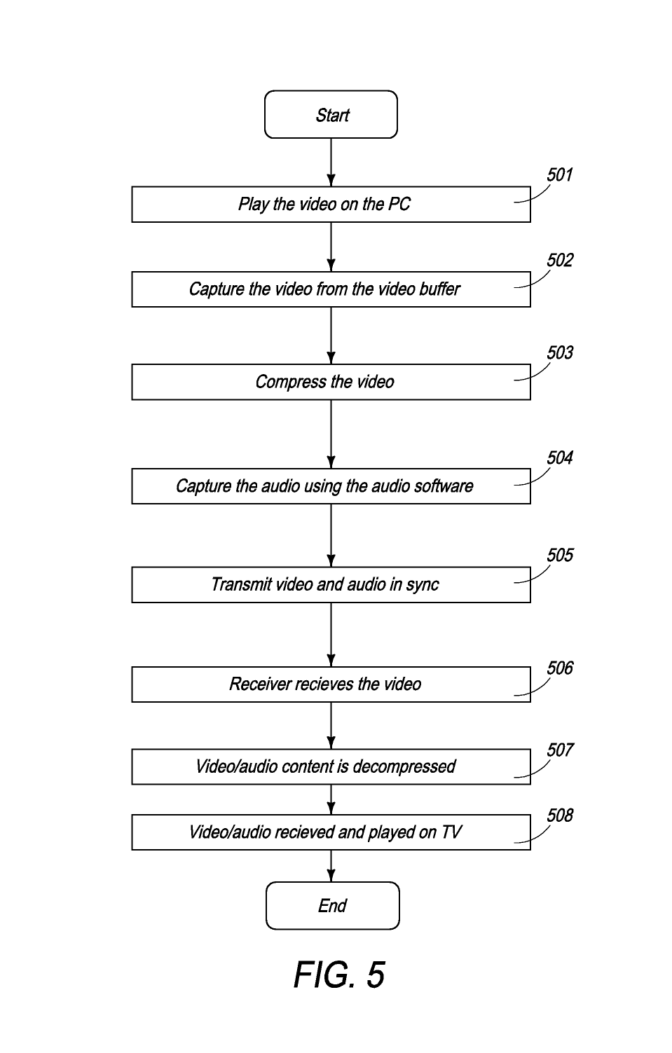

Referring to FIG. 5, the flowchart depicts an exemplary operation of one embodiment of the present invention. The computing device plays 501 the media using appropriate media player for the media type. The media player is stored in a memory that is in data communication with the computing device. Such media player can include players from Apple™ (iPod™), RealNetworks™ (RealPlayer™), Microsoft (Windows Media Player™), or any other media player. The software of the present invention captures 502 the real time video directly from the video buffer. The captured video is then compressed 503 using the CODEC. Similarly, the audio is captured 504 using the audio software operating on the computing device and is compressed using the CODEC.

Various ways of capturing video are within the scope of the present invention. Several exemplary approaches are described below. In one embodiment, the software of the present invention captures video through the implementation of software modules comprising a mirror display driver and a virtual display driver. In one embodiment, the mirror display driver and virtual display driver are installed as components in the kernel mode of the operating system running on the computer that hosts the software of the present invention.

A mirror display driver for a virtual device mirrors the operation of a physical display device driver by mirroring the operations of the physical display device driver. In one embodiment, a mirror display driver is used for capturing the contents of a primary display associated with the computer while a virtual display driver is used to capture the contents of an “extended desktop” or a secondary display device associated with the computer.

In use, the operating system renders graphics and video content onto the video memory of a virtual display driver and a mirror display driver. Therefore, any media being played by the computer using, for example, a media player is also rendered on one of these drivers. An application component of the software of the present invention maps the video memory of virtual display driver and mirror display driver in the application space. In this manner, the application of the present inventions obtains a pointer to the video memory. The application of the present invention captures the real-time images projected on the display (and, therefore, the real-time graphics or video content that is being displayed) by copying the memory from the mapped video memory to locally allocated memory.

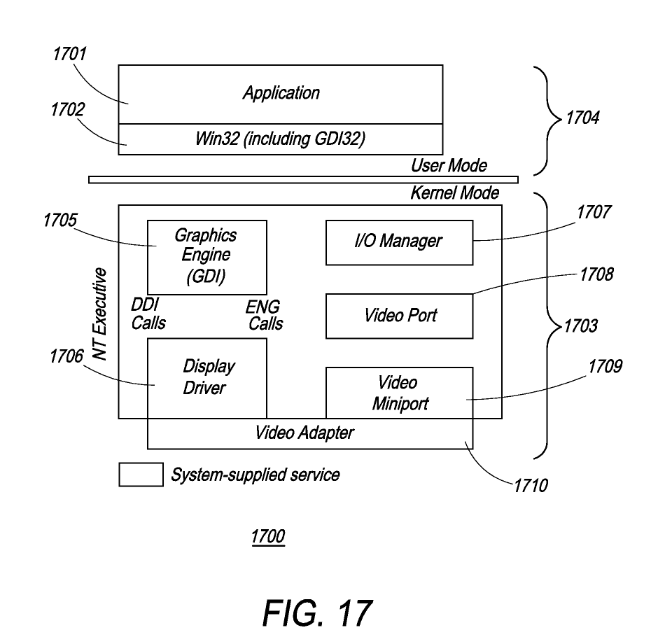

In one embodiment, the mirror display driver and virtual display driver operate in the kernel space of a Microsoft™ operating system, such as a Windows™ 2000/NT compatible operating system. Referring to FIG. 17, an exemplary Microsoft™ Windows framework 1700 for developing display drivers is shown. An application 1701 running on the computer issues a call to a graphics display interface, referred to as the Win32 GDI (Graphics Display Interface) 1702. The GDI 1702 issues graphics output requests. These requests are routed to software operating in the kernel space, including a kernel-mode GDI 1705. The kernel-mode GDI 1705 is an intermediary support between a kernel-mode graphics driver 1706 and an application 1701. Kernel-mode GDI 1705 sends these requests to an appropriate miniport 1709 or graphics driver, such as a display driver 1706 or printer driver [not shown].

For a display driver (DDI) there is a corresponding video miniport 1709. The miniport driver 1709 is written for one graphics adapter (or family of adapters). The display driver 1706 can be written for any number of adapters that share a common drawing interface. This is because the display driver draws, while the miniport driver performs operations such as mode sets and provides information about the hardware to the driver. It is also possible for more than one display driver to work with a particular miniport driver. The active component in this architecture is the Win32-GDI process 1702 and the application 1701. The rest of the components 1705-1710 are called from the Win32-GDI process 1702.

The video miniport driver 1709 generally handles operations that interact with other kernel components 1703. For example, operations such as hardware initialization and memory mapping require action by the NT I/O subsystem. Video miniport driver 1709 responsibilities include resource management, such as hardware configuration, and physical device memory mapping. The video miniport driver 1709 is specific to the video hardware. The display driver 1706 uses the video miniport driver 1709 for operations that are not frequently requested; for example, to manage resources, perform physical device memory mapping, ensure that register outputs occur in close proximity, or respond to interrupts. The video miniport driver 1709 also handles mode set interaction with the graphics card, multiple hardware types (minimizing hardware-type dependency in the display driver), and mapping the video register into the display driver's 1706 address space.

There are certain functions that a driver writer should implement in order to write to a miniport. These functions are exported to the video port with which the miniport interacts. The driver writer specifies the absolute addresses of the video memory and registers, present on the video card, in miniport. These addresses are first converted to bus relative addresses and then to virtual addresses in the address space of the calling process.

The display driver's 1706 primary responsibility is rendering. When an application calls a Win32 function with device-independent graphics requests, the Graphics Device Interface (GDI) 1705 interprets these instructions and calls the display driver 1706. The display driver 1706 then translates these requests into commands for the video hardware to draw graphics on the screen.

The display driver 1706 can access the hardware directly. By default, GDI 1705 handles drawing operations on standard format bitmaps, such as on hardware that includes a frame buffer. A display driver 1706 can hook and implement any of the drawing functions for which the hardware offers special support. For less time-critical operations and more complex operations not supported by the graphics adapter, the driver 1706 can push functions back to GDI 1705 and allow GDI 1705 to do the operations. For especially time-critical operations, the display driver 1706 has direct access to video hardware registers. For example, the VGA display driver for x86 systems uses optimized assembly code to implement direct access to hardware registers for some drawing and text operations.

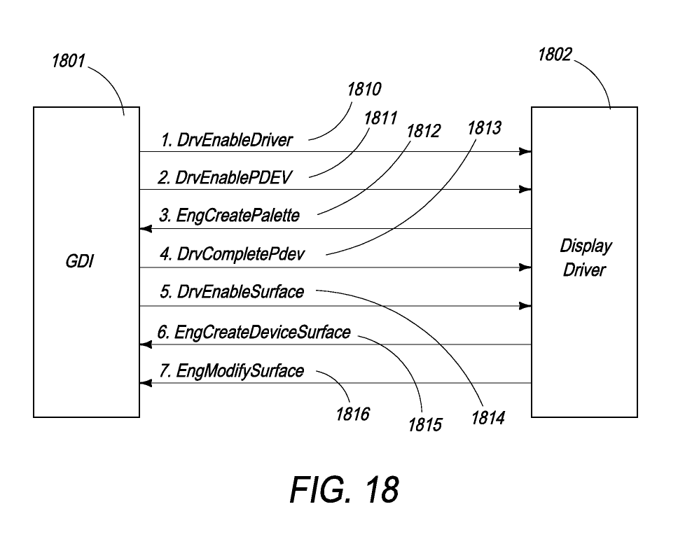

Apart from rendering, display driver 1706 performs other operations such as surface management and palate management. Referring to FIG. 18, a plurality of inputs and outputs between the GDI and display driver are shown. In one embodiment, GDI 1801 issues a DrvEnableDriver command 1810 to the display driver 1802. GDI 1801 then issues a DrvEnablePDEV command 1811 to the display driver 1802. GDI 1801 then receives a EngCreatePalette command 1812 from the display driver 1802. GDI 1801 then issues a DrvCompletePDEV command 1813 to the display driver 1802. GDI 1801 then issues a DrvEnableSurface command 1814 to the display driver 1802. GDI 1801 then receives a EngCreateDevicSurface command 1815 from the display driver 1802 and a EngModifySurface command 1816 from the display driver 1802.

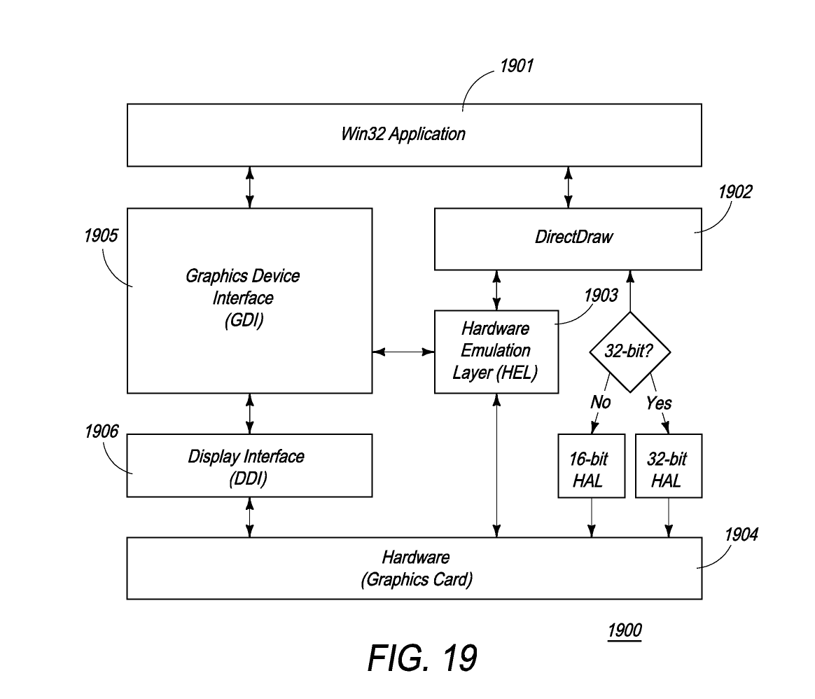

Referring to FIG. 19, a software architecture 1900 for a graphics generation system is shown. The software architecture 1900 represents Microsoft's DirectDraw™, which includes the following components:
1. User-mode DirectDraw™ that is loaded and called by DirectDraw™ applications. This component provides hardware emulation, manages the various DirectDraw™ objects, and provides display memory and display hardware management services.
2. Kernel-mode DirectDraw™, the system-supplied graphics engine that is loaded by a kernel-mode display driver. This portion of DirectDraw™ performs parameter validation for the driver, making it easier to implement more robust drivers. Kernel-mode DirectDraw™ also handles synchronization with GDI and all cross-process states.
3. The DirectDraw™ portion of the display driver, which, along with the rest of the display driver, is implemented by graphics card hardware vendors. Other portions of the display driver handle GDI and other non-DirectDraw™ related calls.

When DirectDraw™ 1900 is invoked, it accesses the graphics card directly through the DirectDraw™ driver 1902. DirectDraw™ 1900 calls the DirectDraw™ driver 1902 for supported hardware functions, or the hardware emulation layer (HEL) 1903 for functions that must be emulated in software. GDI 1905 calls are sent to the driver.

At initialization time and during mode changes, the display driver returns capability bits to DirectDraw™ 1900. This enables DirectDraw™ 1900 to access information about the available driver functions, their addresses, and the capabilities of the display card and driver (such as stretching, transparent bits, display pitch, and other advanced characteristics). Once DirectDraw™ 1900 has this information, it can use the DirectDraw™ driver to access the display card directly, without making GDI calls or using the GDI specific portions of the display driver. In order to access the video buffer directly from the application, it is necessary to map the video memory into the virtual address space of the calling process.

In one embodiment, the virtual display driver and mirror display driver are derived from the architecture of a normal display driver and include a miniport driver and corresponding display driver. In conventional display drivers, there is a physical device, either attached to PCI bus or AGP slot. Video memory and registers are physically present on the video card, which are mapped in the address space of the GDI process or the capturing application using DirectDraw. In the present embodiment, however, there is no physical video memory. The operating system assumes the existence of a physical device (referred to as a virtual device) and its memory by allocating memory in the main memory, representing video memory and registers. When the miniport of the present invention is loaded, a chunk of memory, such as 2.5 MB, is reserved from the non-paged pool memory. This memory serves as video memory. This memory is then mapped in the virtual address space of the GDI process (application in case of a graphics draw operation). When the display driver of the present invention requests a pointer to the memory, the miniport returns a pointer to the video memory reserved in the RAM. It is therefore transparent to the GDI and display device interface (DDI) (or application in case of direct draw) whether the video memory is on a RAM or a video card. DDI or GDI perform the rendering on this memory location. The miniport of the present invention also allocates a separate memory for overlays. Certain applications and video players like Power DVD, Win DVD etc uses overlay memory for video rendering.

In one conventional embodiment, rendering is performed by the DDI and GDI. GDI provides the generic device independent rendering operations while DDI performs the device specific operation. The display architecture layers GDI over DDI and provides a facility that DDI can delegate it's responsibilities to GDI. In an embodiment of the present invention, because there is no physical device, there are no device specific operations. Therefore, the display driver of the present invention delegates the rendering operations to GDI. DDI provides GDI with the video memory pointer and GDI perform the rendering based on the request received from the Win32 GDI process. Similarly, in the case where the present invention is compatible with DirectDraw, the rendering operations are delegated to the HEL (Hardware emulation layer) by DDI.

In one embodiment, the present invention comprises a mirror driver which, when loaded, attaches itself to a primary display driver. Therefore, all the rendering calls to the primary display driver are also routed to the mirror driver and whatever data is rendered on the video memory of the primary display driver is also rendered on the video memory of the mirror driver. In this manner, the mirror driver is used for computer display duplication.

In one embodiment, the present invention comprises a virtual driver which, when loaded, operates as an extended virtual driver. When the virtual driver is installed, it is shown as a secondary driver in the display properties of the computer and the user has the option on extend the display on to this display driver.

In one embodiment, the mirror driver and virtual driver support the following resolutions: 640*480, 800*600, 1024*768, and 1280*1024. For each of these resolutions, the drivers support 8, 16, 24, 32 bit color depths and 60 and 75 Hz refresh rates. Rendering on the overlay surface is done in YUV 420 format.

In one embodiment, a software library is used to support the capturing of a computer display using the mirror or virtual device drivers. The library maps the video memory allocated in the mirror and virtual device drivers in the application space when it is initialized. In the capture function, the library copies the mapped video buffer in the application buffer. In this manner, the application has a copy of the computer display at that particular instance.

For capturing the overlay surfaces, the library maps the video buffer in the application space. In addition, a pointer is also mapped in the application space which holds the address of the overlay surface that was last rendered. This pointer is updated in the driver. The library obtains a notification from the virtual display driver when rendering on the overlay memory starts. The display driver informs the capture library of the color key value. After copying the main video memory, a software module, CAPI, copies the last overlay surface rendered using the pointer which was mapped from the driver space. It does the YUV to RGB conversion and pastes the RGB data, after stretching to the required dimensions, on the rectangular area of the main video memory where the color key value is present. The color key value is a special value which is pasted on the main video memory by the GDI to represent the region on which the data rendered on the overlay should be copied. In use on computers operating current Windows™/NT operating systems, overlays only apply to the extended virtual device driver and not the mirror driver because, when the mirror driver is attached, DirectDraw™ is automatically disabled.

While the video and graphics capture method and system has been specifically described in relation to Microsoft™ operating systems, it should be appreciated that a similar mirror display driver and virtual display driver approach can be used with computers operating other operating systems.

In one embodiment, audio is captured using through an interface used by conventional computer-based audio players to play audio data. In one embodiment, audio is captured using Microsoft Windows Multimedia™ API, which is a software module compatible with Microsoft Windows™ and NT operating systems. A Microsoft Windows™ Multimedia Library provides an interface to the applications to play audio data on an audio device using waveOut calls. Similarly, it also provides interfaces to record audio data from an audio device. The source for recording device can be line in, microphone, or any other source designation. The applications can specify the format (sampling frequency, bits per sample) in which it wants to record the data. An exemplary set of steps for audio capture in a Windows/NT compatible operating system computing environment are as follows.

1. An application opens the audio device using waveInOpen( ) function. It specifies the audio format in which to record, the size of audio data to capture at a time and callback function to call when the specified size to audio data is available

2. The application passes a number of empty audio buffers to the windows audio subsystem using waveInAddBuffer( ) call.

3. To specify start of capture the application calls waveInStart( )

4. When the specified size of audio data is available, the Windows audio subsystem calls the callback function through which it passes the audio data to the application in one of the audio buffers which were passed by the application.

5. The application copies the audio data into its local buffer and, if it needs to continue capturing again, passes the empty audio buffer to the Windows audio subsystem through waveInAddBuffer( )

6. When the application needs to stop capturing, the application calls waveInClose( )

In one embodiment, a stereo mix option is selected in a media playback application and audio is captured in the process. Audio devices typically have the capability to route audio, being played on an output pin, back to an input pin. While named differently on different systems, it is generally referred to as a “stereo mix”. If the stereo mix option is selected in the playback option, and audio is recorded from the default audio device using waveIn call, then everything that is being played on the system can be recorded. i.e the audio being played on the system can be captured. It should be appreciated that the specific approach is dependent on the capabilities of the particular audio device being used and that one of ordinary skill in the art would know how to capture the audio stream in accordance with the above teaching. It should also be appreciated that, to prevent the concurrent playback of audio from the computer and the remote device, the local audio (on the computer) should be muted, provided that such muting does not also mute the audio routing to the input pin.

In another embodiment, a virtual audio driver, referred to as a virtual audio cable (VAC), is installed as a normal audio driver that can be selected as a default playback and/or recording device. A feature of VAC is that, by default, it routes all the audio going to its audio output pin to its input pin. Therefore, if VAC is selected as a default playback device, then all the audio being played on the system would go to the output pin of VAC and hence to its input pin. If any application captures audio from the input pin of VAC using the appropriate interface, such as the waveIn API, then it would be able to capture everything that is being played on that system. In order to capture audio using VAC, it would have to be selected as a default audio device. Once VAC is selected as a default audio device, then the audio on the local speaker would not be heard.

Other mechanisms for capturing video, graphics, and/or audio data can be used in the present invention. In one embodiment, the software comprises a set of instructions that captures video, graphics, or audio data from the appropriate buffers before it is written to display or an audio device. Conventionally, data to be rendered is first processed by a plurality of processors and the results of that data processing is placed into buffer(s), which are intended to be areas of temporary data storage pending a read out to the computer display or audio device. Prior to the data in the buffer being read out to display or audio device, an instruction set of the present application captures a copy of the processed data, encodes the data, and wirelessly transmits the data in accordance with the descriptions below.

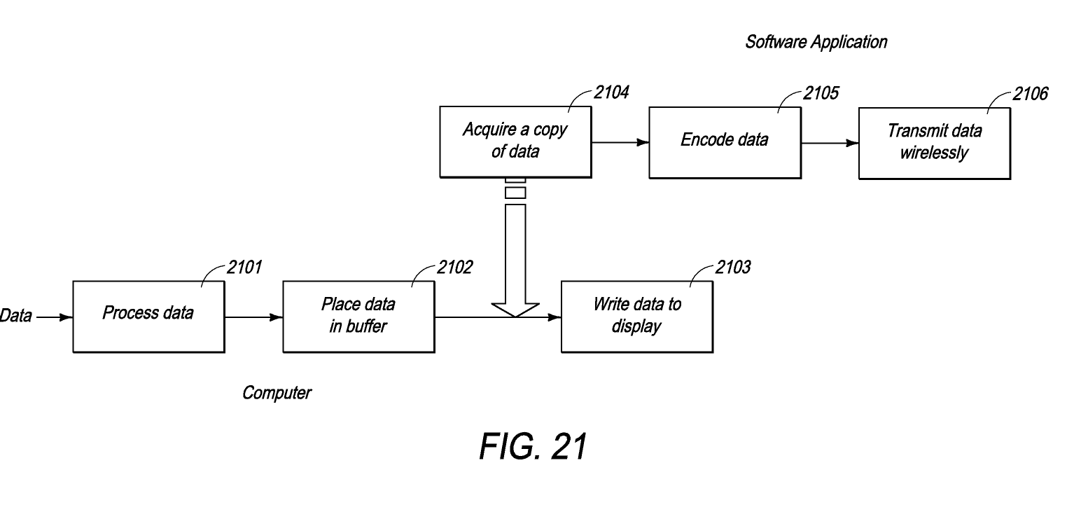

The process flow for this data capture function is illustrated in FIG. 21. Data is first processed and placed into a display or audio device. The processing functions typically involve decoding and decompressing data. These steps are depicted in steps 2101 through 2103 of the process flow diagram. After the processed data is placed in display or audio device buffer(s), the software application of the present embodiment captures a copy of the video, graphics, or audio data from the appropriate buffers just before it is written to display or the audio device. The captured copy of data can be then encoded and wirelessly transmitted to another display device, such as a television or other output device. These functions of the software application are depicted in steps 2104 through 2106 of the process flow diagram.

In another embodiment, the software modifies, or is integrated into, at least in part, the kernel of an operating system. By incorporating at least some of the instructions sets of the present application into the operating system, the data can be captured at any time after the data is conventionally processed, e.g. decoded and decompressed. Once the data is copied, it can be re-encoded and transmitted, in accordance with the descriptions herein. One benefit of this approach is that data can be rendered on a computing device and, in real-time and in parallel, can also be rendered on a separate display device. Accordingly, the present invention includes the capture of processed data, namely data that has been decoded and decompressed, from data buffers that are in kernel memory (or under the control of the kernel in a kernel mode of operation) and the re-encoding and transmission of that data, in accordance with the descriptions herein, concurrent with the rendering of that data on a local display. In this embodiment, the re-encoding and transmission of data, concurrent with the rendering of that data on a local display, is under the control of the operating system. Optionally, the data may not be rendered on the local display.

Referring back to FIG. 5, regardless of how the data is captured, the graphics, audio and video data (after compression 503) are transmitted 505 simultaneously in a synchronized manner wirelessly to a receiver. The receiver, which is in data communication with the remote monitoring device receives 506 the compressed media data. The media data is then uncompressed 507 using the CODEC. The data is then finally rendered 508 on the display device. A TV is just one any number of display devices.

To transmit the media, any transmission protocol may be employed. However, it is preferred to transmit separate video and audio data streams, in accordance with a hybrid TCP/UDP protocol, that are synchronized using a clock or counter. Specifically, a clock or counter sequences forward to provide a reference against which each data stream is timed.

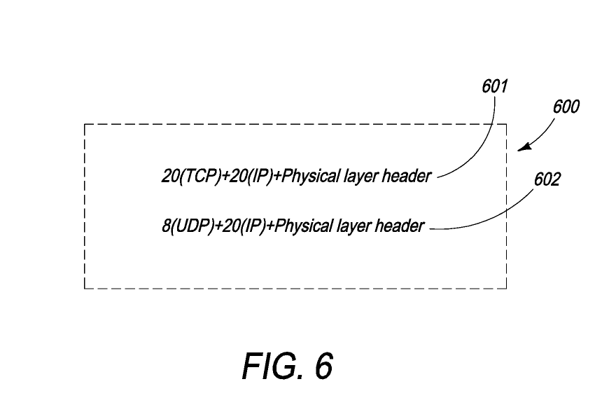

Referring to FIG. 6, an embodiment of the abovementioned TCP/UDP hybrid protocol is depicted. The TCP/UDP hybrid protocol 600 comprises of a TCP packet header 601 of size equivalent to 20 TCP, 20 IP and a physical layer header and UDP packet header 602 of size equivalent to 8 TCP, 20 IP and a physical layer header.

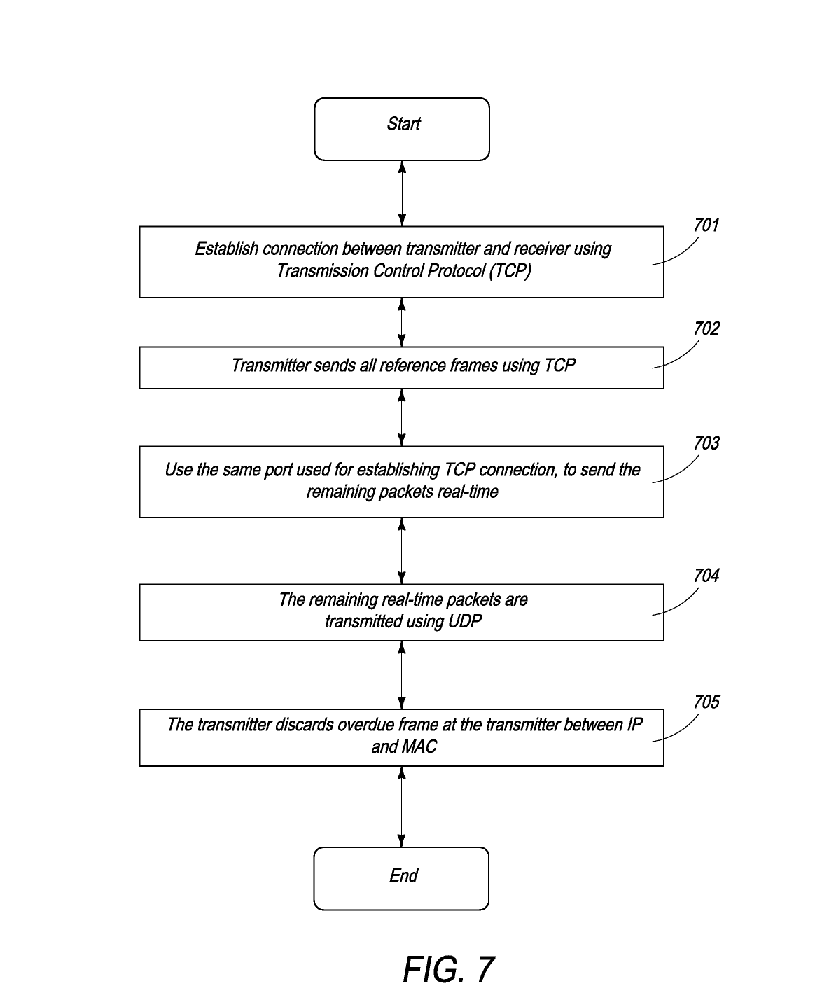

FIG. 7 is a flow diagram that depicts the functional steps of the TCP/UDP real-time (RT) transmission protocol implemented in the present invention. The transmitter and receiver, as previously described, establish 701 connection using TCP and the transmitter sends 702 all the reference frames using TCP. Thereafter, the transmitter uses 703 the same TCP port, which was used to establish connection in step 701, to send rest of the real-time packets but switches 704 to the UDP as transport protocol. While transmitting real-time packets using UDP, the transmitter further checks for the presence of an RT packet that is overdue for transmission. The transmitter discards 705 the overdue frame at the transmitter itself between IP and MAC. However an overdue reference frame/packet is always sent. Thus, the TCP/UDP protocol significantly reduces collisions while substantially improving the performance of RT traffic and network throughput.

The TCP/UDP protocol is additionally adapted to use ACK spoofing as a congestion-signaling method for RT transmission over wireless networks. Sending RT traffic over wireless networks can be sluggish. One of the reasons for this is that after transmission of every block of data TCP conventionally requires the reception of an ACK signal from the destination/receiver before resuming the transmission of the next block or frame of data. In IP networks, specifically wireless, there remain high probabilities of the ACK signals getting lost due to network congestion, particularly so in RT traffic. Thus, since TCP does both flow control and congestion control, this congestion control causes breakage of connection over wireless networks owing to scenarios such as non-receipt of ACK signals from the receiver.

To manage breakage of connection, the present invention, in one embodiment, uses ACK spoofing for RT traffic sent over networks. By implementing ACK spoofing, if the receiver does not receive any ACK within a certain period of time, the transmitter generates a false ACK for the TCP, so that it resumes sending process. In an alternate embodiment, in the event of poor quality of transmission due to congestion and reduced network throughput, the connection between the transmitter and receiver is broken and a new TCP connection is opened to the same receiver. This results in clearing congestion problems associated with the previous connection. It should be appreciated that this transmission method is just one of several transmission methods that could be used and is intended to describe an exemplary operation.

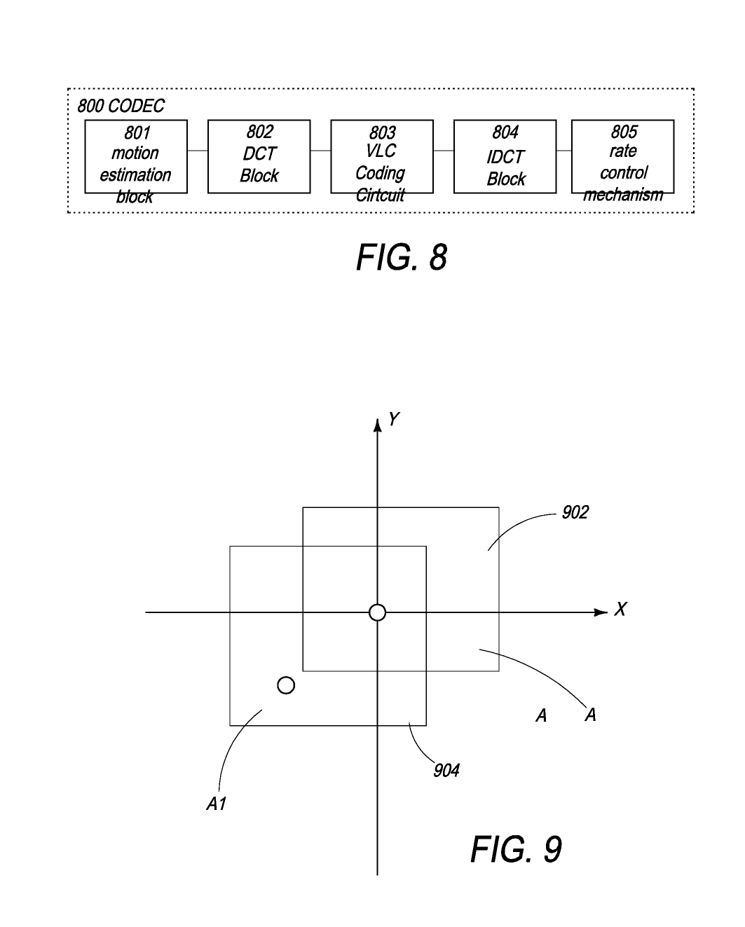

Referring to FIG. 8, the block diagram depicts the components of the CODEC of the integrated wireless system. The CODEC 800 comprise a motion estimation block 801 which removes the temporal redundancy from the streaming content, a DCT block 802 which converts the frame into 8*8 blocks of pixels to perform DCT, a VLC coding circuit 803 which further codes the content into shorter words, an IDCT block 804 converts back the spatial frequencies to the pixel domain, and a rate control mechanism 805 for speeding up the transmission of media.

The motion estimation block 801 is used to compress the video by exploiting the temporal redundancy between the adjacent frames of the video. The algorithm used in the motion estimation is preferably a full search algorithm, where each block of the reference frame is compared with the current frame to obtain the best matching block. The full search algorithm, as the term suggests, takes every point of a search region as a checking point, and compares all pixels between the blocks corresponding to all checking points of the reference frame and the block of the current frame. Then the best checking point is determined to obtain a motion vector value.

For example, FIG. 9 depicts the functional steps of the one embodiment of the motion estimation block. The checking points A and A1 shown in the figure respectively correspond to the blocks 902 and 904 in a reference frame. If the checking point A is moved left and downward by one pixel, it becomes the checking point A1. In this way, when the block 902 is shifted left and downward by one pixel, it results in the block 904.

The comparison technique is performed by computing the difference in the image information of all corresponding pixels and then summing the absolute values of the differences in the image information. Finally, the sum of absolute difference (SAD) is performed. Then, among all checking points, the checking point with the lowest SAD is determined to be the best checking point. The block that corresponds to the best checking point is the block of the reference frame, which matches best with the block of the current frame that is to be encoded. And these two blocks obtain a motion vector.

Referring back to FIG. 8, once the motion estimation is carried out the picture is coded using a discrete cosine transform (DCT) via the DCT block 802. The DCT coding scheme transforms pixels (or error terms) into a set of coefficients corresponding to the amplitudes of specific cosine basis functions. The discrete cosine transform (DCT) is typically regarded as the most effective transform coding technique for video compression and is applied to the sampled data, such as digital image data, rather than to a continuous waveform.

Usage of the DCT for image compression is advantageous because the transform converts N (point) highly correlated input spatial vectors in the form of rows and columns of pixels into N point DCT coefficient vectors including rows and columns of DCT coefficients in which high frequency coefficients are typically zero-valued. Energy of a spatial vector, which is defined by the squared values of each element of the vector, is preserved by the DCT transform so that all energy of a typical, low-frequency and highly-correlated spatial image is compacted into the lowest frequency DCT coefficients. Furthermore, the human psycho visual system is less sensitive to high frequency signals so that a reduction in precision in the expression of high frequency DCT coefficients results in a minimal reduction in perceived image quality. In one embodiment 8*8 block resulting from the DCT block is divided by a quantizing matrix to reduce the magnitude of the DCT coefficients. In such a case, the information associated to the highest frequencies less visible to human sight tends to be removed. The result is reordered and sent to the variable length-coding block 803.

Variable length coding (VLC) block 803 is a statistical coding block that assigns codewords to the values to be encoded. Values of high frequency of occurrence are assigned short codewords, and those of infrequent occurrence are assigned long codewords. On an average, the more frequent shorter codewords dominate so that the code string is shorter than the original data. VLC coding, which generates a code made up of DCT coefficient value levels and run lengths of the number of pixels between nonzero DCT coefficients, generates a highly compressed code when the number of zero-valued DCT coefficients is greatest. The data obtained from the VLC coding block is transferred to the transmitter at an appropriate bit rate. The amount of data transferred per second is known as bit rate.

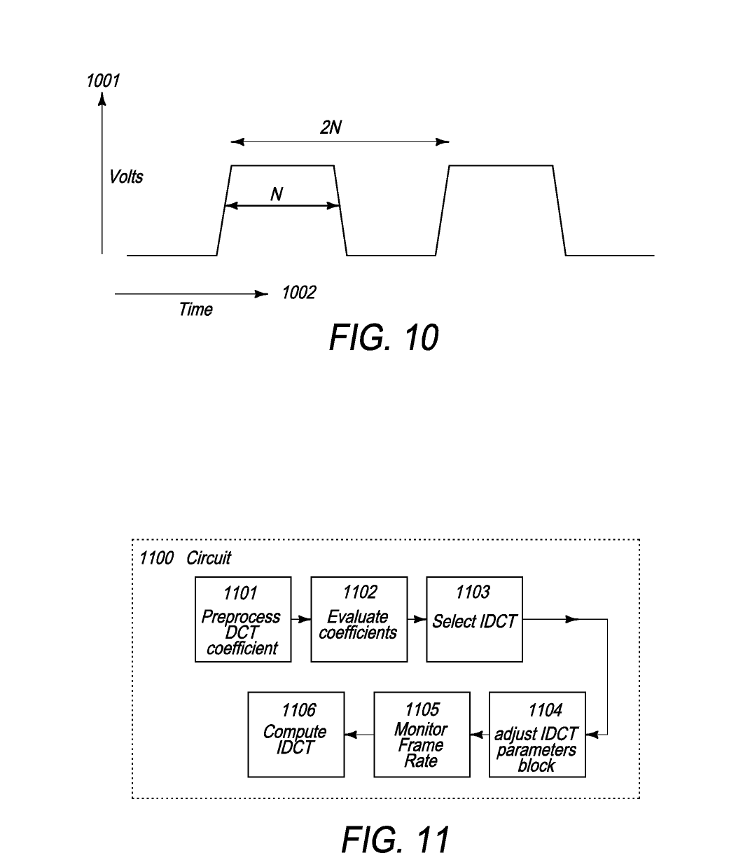

FIG. 10 depicts the exemplary digital signal waveform and data transfer. The vertical axis 1001 represents voltage and the horizontal axis 1002 represents time. The digital waveform has a pulse width of N and a period (or cycle) of 2N where N represents the bit time of the pulse (i.e., the time during which information is transferred). The pulse width, N, may be in any units of time such as nanoseconds, microseconds, picoseconds, etc. The maximum data rate that may be transmitted in this manner is 1/N transfers per second, or one bit of data per half cycle (the quantity of time labeled N). The fundamental frequency of the digital waveform is ½N hertz. In one embodiment, simplified rate control is employed which increases the bit rate of the data by 50% compared to MPEG2 using the method described above. Consequently in less time there is large chunk of data being transferred to the transmitter making the process real time.

The compressed data is then transmitted, in accordance with the above-described transmission protocol, and wirelessly received by the receiver. To provide motion video capability, compressed video information must be quickly and efficiently decoded. The aspect of the decoding process, which is used in the preferred embodiment, is inverse discrete cosine transformation. Inverse discrete cosine transform (IDCT) converts the transform-domain data back to spatial-domain form. A commonly used two-dimensional data block size is 8*8 pixels, which furnishes a good compromise between coding efficiency and hardware complexity. The inverse DCT circuit performs an inverse digital cosine transform on the decoded video signal on a block-by-block basis to provide a decompressed video signal.

Referring to FIG. 11, a diagram of the processing and selective optimization of the IDCT block is depicted. The circuit 1100 includes a preprocess DCT coefficient block (hereinafter PDCT) 1101, an evaluate coefficients block 1102, a select IDCT block 1103, a compute IDCT block 1104, a monitor frame rate block 1105 and an adjust IDCT parameters block 1106. In operation, the wirelessly transmitted media, received from the transmitter, includes various coded DCT coefficients, which are routed to the PDCT block 1101. The PDCT block 1101 selectively sets various DCT coefficients to a zero value to increase processing speed of the inverse discrete cosine transform procedure with a slight reduction or no reduction in video quality. The DCT coefficient-evaluating block 1102 then receives the preprocessed DCT coefficient from the PDCT 1101. The evaluating circuit 1102 examines the coefficients in a DCT coefficient block before computation of the inverse discrete cosine transform operation. Based on the number of non-zero coefficients, an inverse discrete cosine transform (IDCT) selection circuit 1103 selects an optimal IDCT procedure for processing of the coefficients. The computation of the coefficients is done by the compute IDCT block 1104. In one embodiment, several inverse discrete cosine transform (IDCT) engines are available for selective activation by the selection circuit 1103. Typically, the inverse discrete cosine transformed coefficients are combined with other data prior to display. The monitor frame rate block 1105 thereafter determines an appropriate frame rate of the video system, for example by reading a system clock register (not shown) and comparing the elapsed time with a prestored frame interval corresponding to a desired frame rate. The adjust IDCT parameter block 1106 then adjusts parameters including the non-zero coefficient threshold, frequency and magnitude according to the desired or fitting frame rate.

The abovementioned IDCT block computes an inverse discrete cosine transform in accordance with the appropriate selected IDCT method. For example, an 8*8 forward discrete cosine transform (DCT) is defined by the following equation:

$$X ( u , v ) = ( 1 / 4 ) C ( u ) C ( v ) \sum \text{?} \sum \text{?} x ( i , j ) cos ( \frac{\text{?}}{16} ) cos ( \frac{\text{?}}{16} ) : \\ \text{?} \text{indicates text missing or illegible when filed}$$

where x(i,j) is a pixel value in an 8*8 image block in spatial domains i and j, and X (u,v) is a transformed coefficient in an 8*8 transform block in transform domains u,v. C(0) is 1/.sqroot.2 and C(u)=C(v)=1.

An inverse discrete cosine transform (IDCT) is defined by the following equation:

$$x ( i , j ) = ( 1 / 4 ) \sum \text{?} \sum \text{?} \text{?} X \text{?} cos ( \text{?} ) . \\ \text{?} \text{indicates text missing or illegible when filed}$$

An 8*8 IDCT is considered to be a combination of a set of 64 orthogonal DCT basis matrices, one basis matrix for each two-dimensional frequency (v, u). Furthermore, each basis matrix is considered to be the two-dimensional IDCT transform of each single transform coefficient set to one. Since there are 64 transform coefficients in an 8*8 IDCT, there are 64 basis matrices. The IDCT kernel K(v, u), also called a DCT basis matrix, represents a transform coefficient at frequency (v, u) according to the equation:

K(v,u)=.nu.(u).nu.(v)cos((2m+1).pi.u/16)cos((2n+1).pi.v/16),

where .nu.(u) and .nu.(v) are normalization coefficients defined as .nu.(u)=1/.sqroot.8 for u=0 and .nu.(u)=1/2 for u>0. The IDCT is computed by scaling each kernel by the transform coefficient at that location and summing the scaled kernels. The spatial domain matrix S is obtained using the equation, as follows

$$S = \sum \text{?} F K ( , u ) . \\ \text{?} \text{indicates text missing or illegible when filed}$$

It should be appreciated that a 4*4 transform block could be used as well.

It should further be appreciated that any compression/decompression or encoding/decoding protocol or format could be used. Specifically, the instruction sets of the present invention, which can be implemented in one or more computing devices or any combination of one or more computing devices, can employ standard conventional compression/decompression or encoding/decoding formats, thereby enabling communication between a computing device and any IP-enabled device connected to, or integrated into, a television or display device. For example, any one of, or a combination of, MPEG 2, DivX, WMV, H.264, AAF, AAC, AC-3, AES3, AIFF, AMR, ARC, ASF, AudCom, AVI, BIIF, CAM, CDF, Cinepak, CPC, CR2, CRW, DCI, DCR, DivX, DLS, DNG, DPX, DSD, DSDIFF, DTB, DTS, DV, Exif, FLAC, Flash (SWF, FLA, FLV), GIF, H.26 (n), HD Photo, ID3, IFF, Indeo, ISO_BMFF, ITU_G4, JPEG, JF1F, J2K, JP2, KDC, LPCM, LZW, MIDI, MJPEG, MJP2, MODS, MP3, MPEG-1, MPEG-4, AAC, MrSID, MRW, MXF, NEF, OEBPS, Ogg, ORF, PCM, PEF, PNG, QuickTime, RAF, RealAudio, RealVideo, RIFF, RMID, SHN, Sorenson, SMF, SPIFF, SRF, SVG, SWF, TGA, TIFF, VC-1, Vorbis, WARC, WAVE, WM, WMA, WMP, X3F, X3F, and XMF formats can be used.

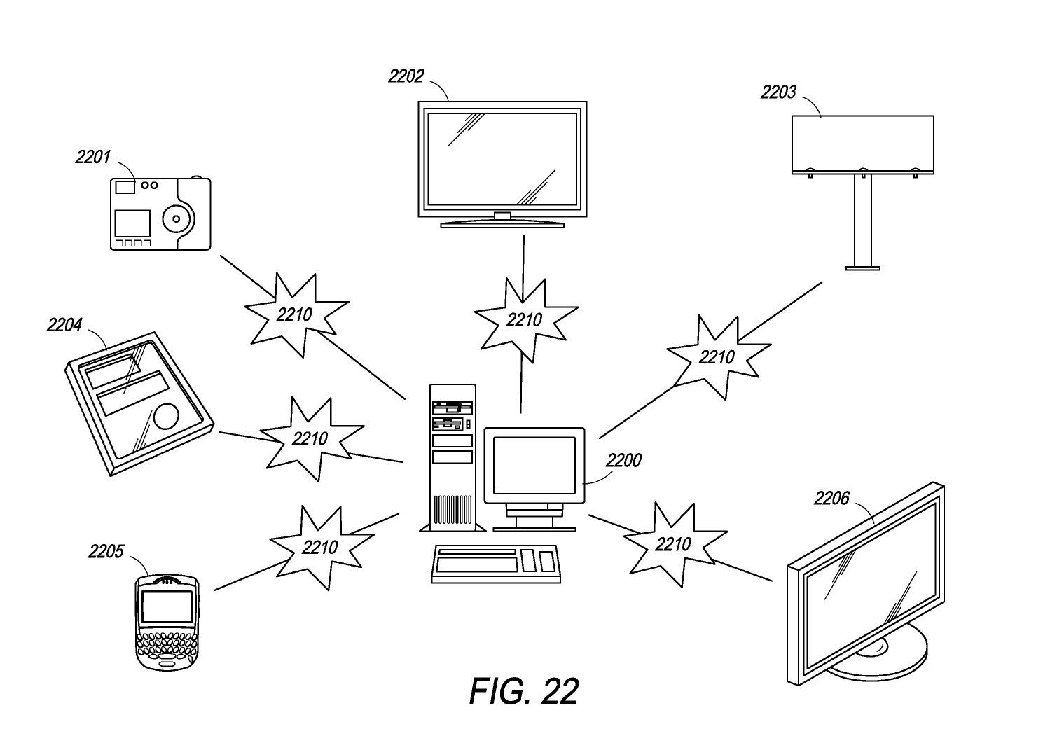

In one example, for rendering on a television display, the encoded data from a computing device is transmitted to any IP enabled device in communication with the television, such as a set top box, DVD player, gaming console, digital video recorder, or any other IP enabled device. Referring to FIG. 22, data is transmitted wirelessly from the PC 2201 if the IP enabled device 2202 has wireless communication capability. In this case, the IP enabled device 2202 is updated with software that allows it to communicate with a PC and recognize data as being received from the PC. The IP enabled device may further transmit content, received in accordance with the present invention, in a wired or wireless manner to the television 2203 for display. If the IP enabled device in communication with the television does not have built-in wireless communication capability, the feature may be provided by means of a standard USB-wireless receiver. In this case, the IP enabled device is a satellite device to the PC, which is the central networked computing device.

It should also be appreciated that the methods and systems of the present invention enable very high quality video transmissions, preferably allowing for the transmission and reception of video in the range of above 20 frames per second and more preferably at least 24 to 30 frames per second.

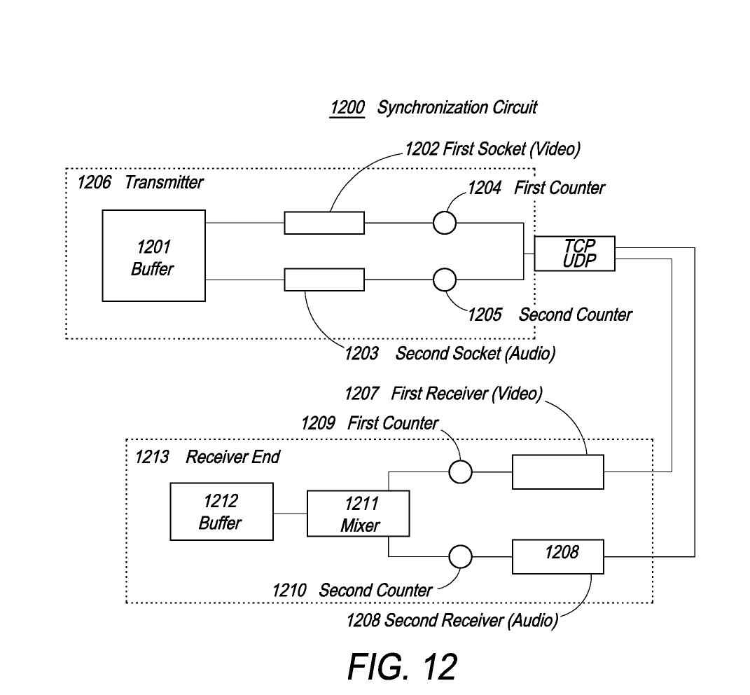

As previously discussed, while the various media streams may be multiplexed and transmitted in a single stream, it is preferred to transmit the media data streams separately in a synchronized manner. Referring to FIG. 12, the block diagram depicts the components of the synchronization circuit for synchronizing media data of the integrated wireless system. The synchronization circuit 1200 comprises a buffer 1201 having the video and audio media, first socket 1202 for transmitting video and second socket 1203 for transmitting audio, first counter 1204 and second counter 1205 at the transmitter 1206 and first receiver 1207 for video data, second receiver 1208 for audio data, first counter 1209, second counter 1210, mixer 1211 and a buffer 1212 at receiver end 1213.

Operationally, the buffered audio and video data 1201 at the transmitter 1206 after compression is transmitted separately on the first socket 1202 and the second socket 1203. The counters 1204, 1205 add an identical sequence number both to the video and audio data prior to transmission. In one embodiment, the audio data is preferably routed via User Datagram Protocol (UDP) whereas the video data via Transmission Controlled Protocol (TCP). At the receiver end 1213, the UDP protocol and the TCP protocol implemented by the audio receiver block 1208 and the video receiver block 1207 receives the audio and video signals. The counters 1209, 1210 determine the sequence number from the audio and video signals and provide it to the mixer 1211 to enable the accurate mixing of signals. The mixed data is buffered 1212 and then rendered by the remote monitor.

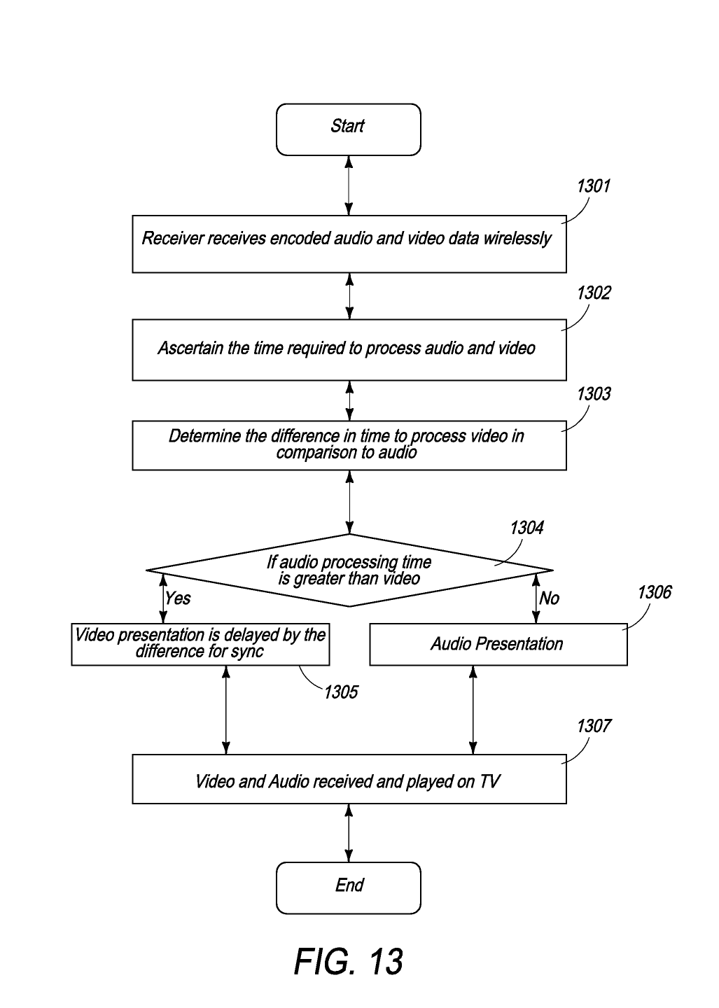

Referring to FIG. 13, the flowchart depicts another embodiment of synchronizing audio and video signals of the integrated wireless system of the present invention. Initially, the receiver receives 1301 a stream of encoded video data and encoded audio data wirelessly. The receiver then ascertains 1302 the time required to process the video portion and the audio portion of the encoded stream. After that, the receiver determines 1303 the difference in time to process the video portion of the encoded stream as compared to the audio portion of the encoded stream. The receiver subsequently establishes 1304 which processing time is greater (i.e., the video processing time or the audio processing time).

If the audio processing time is greater, the video presentation is delayed 1305 by the difference determined, thereby synchronizing the decoded video data with the decoded audio data. However, if the video processing time is greater, the audio presentation is not delayed and played at its constant rate 1306. Video presentation tries to catch up the audio presentation by discarding video frames after regular intervals. The data is then finally rendered 1307 on the remote monitor. Therefore, audio “leads” video meaning that the video synchronizes itself with the audio.

In a particular embodiment, the decoded video data is substantially synchronized with the decoded audio data. Substantially synchronized means, that while there may be a slight, theoretically measurable difference between the presentation of the video data and the presentation of the corresponding audio data, such a small difference in the presentation of the audio and video data is not likely to be perceived by a user watching and listening to the presented video and audio data.

A typical transport stream is received at a substantially constant rate. In this situation, the delay that is applied to the video presentation or the audio presentation is not likely to change frequently. Thus, the aforementioned procedure may be performed periodically (e.g., every few seconds or every 30 received video frames) to be sure that the delay currently being applied to the video presentation or the audio presentation is still within a particular threshold (e.g., not visually or audibly perceptible). Alternatively, the procedure may be performed for each new frame of video data received from the transport stream.

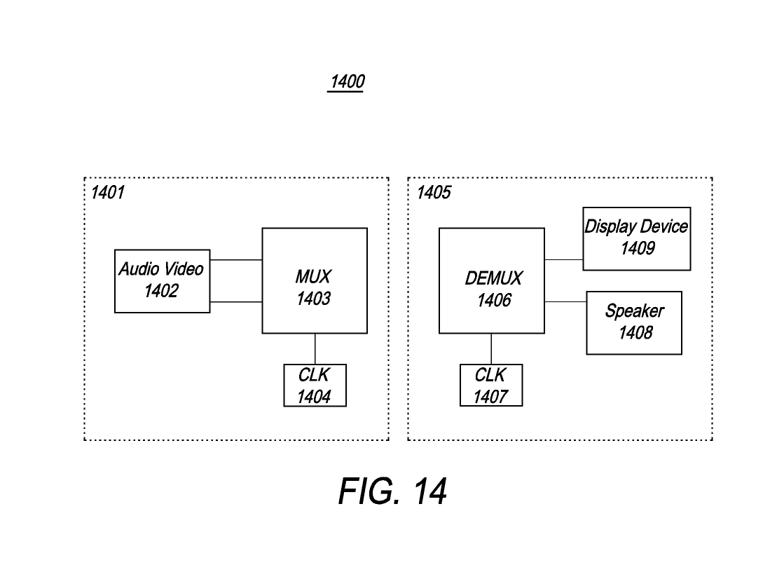

Referring to FIG. 14, another embodiment of the audio and video synchronization circuit is depicted. The synchronization circuit 1400 at the transmitter end 1401 comprises buffer 1402 having media data, multiplexer 1403 for combining the media data signals, such as graphics, text, audio, and video signals, and a clock 1404 for providing the timestamps to the media content for synchronization. At the receiver end 1405 the demultiplexer 1406 using clock 1407 devolves the data stream into the individual media data streams. The timestamps provided by the clocks help synchronize the audio and video at the receiver end. The clock is set at the same frequency as that of receiver. The audio and video, which is demultiplexed, is routed to the speakers 1408 and display device 1409 for rendering.

It should be appreciated that the encoder on the transmitting computing device may be tailored to, or customized to, the nature of the receiving device. For example, the encoder may differ depending on whether the receiving device is a television equipped with a receiver or a cell phone. In one embodiment, the encoder of the present invention further comprises a module to encode data in accordance with specific encoding standards for different cell phone platforms. It should be appreciated that the receiving device, e.g. mobile phone, would then have the software receiving modules described above to receive the transmitted, encoded data streams.

### Software Install and Device Configuration

In one embodiment, the present invention provides a system and method of automatically downloading, installing, and updating the novel software of the present invention on the computing device or remote monitor. No software CD is required to install software programs on the remote monitor, the receiver in the remote monitor, the computing device, or the transmitter in the computing device. As an example, a personal computer communicating to a wireless projector is provided, although the description is generic and will apply to any combination of computing device and remote monitor. It is assumed that both the personal computer and wireless projector are in data communication with a processing system on chip, as previously described.

On start up, the wireless projector (WP-AP) runs a script to configure itself as an access point. The WP-AP sets the SSID as QWPxxxxxx where ‘xxxxxx’ is lower 6 bytes of AP's MAC Address. The WP-AP sets its IP Address as 10.0.0.1. WP-AP starts an HTTP server. WP-AP starts the DHCP server, with following settings in the configuration file

Start Address: 10.0.0.3

End Address: 10.0.0.254

DNS: 10.0.0.1

Default Gateway: 10.0.0.1

[Second and Third Octet of the Addresses are Configurable]

The WP-AP starts a small DNS server, configured to reply 10.0.0.1 (i.e. WP-AP's address) for any DNS query. The IP Address in the response will be changed if the WP-AP's IP Address is changed. The default page of HTTP server has a small software program, such as a Java Applet, that conducts the automatic software update. The error pages of the HTTP server redirect to the default page, making sure that the default page is always accessed upon any kind of HTTP request. This may happen if the default page on the browser has some directory specified as well, e.g. http://www.microsoft.com/isapi/redir.dll?prd=ie&pver=6&=msnhome

The WP-AP, through its system on chip and transceiver, communicates its presence as an access point. The user's computing device has a transceiver capable of wirelessly transmitting and receiving information in accordance with known wireless transmission protocols and standards. The user's computing device recognizes the presence of the wireless projector, as an access point, and the user instructs the computing device to join the access point through graphical user interfaces that are well known to persons of ordinary skill in the art.

After joining the wireless projector's access point, the user opens a web browser application on the computing device and types into a dialog box and any URL, or permits the browser to revert to a default URL. The opening of the web browser accesses the default page of WP-AP HTTP server and results in the initiation of the software program (e.g. Java Applet).

In one embodiment, the software program checks if the user's browser supports it in order to conduct an automatic software update. The rest of the example will be described in relation to Java but it should be appreciated that any software programming language could be used.

If Java is supported by the browser, the applet will check if the software and drivers necessary to implement the media transmission methods described herein are already installed. If already present, then the Java Applet compares the versions and automatically initiates installation if the computing device software versions are older than the versions on the remote monitor.

If Java is not supported by the browser, the user's web page is redirected to an installation executable, prompting the user to save it or run it. The page will also display instructions of how to save and run the installation. The installation program also checks if the user has already installed the software and whether the version needs to be upgraded or not. In this case user will be advised to Install Java.

In a first embodiment, the start address for WP-AP's DNS server is 10.0.0.2. WP-AP runs the DHCP client for its Ethernet connection and obtains IP, Gateway, Subnet and DNS addresses from the DHCP Server on the local area network. If the DHCP is disabled then it uses static values. The installation program installs the application, uninstaller, and drivers. The application is launched automatically. On connection, the application obtains the DNS address of WP-AP's Ethernet port, and sets it on the local machine. After the connection is established, WP-AP enables IP Forwarding and sets the firewall such that it only forwards packets from the connected application to the Ethernet and vice versa. These settings enable the user to access the Ethernet local area network of WP-AP and access the Internet. The firewall makes sure that only the user with his/her application connected to the WP-AP can access LAN/Ethernet. On disconnection, WP-AP disables IP Forwarding and restores the firewall settings. The application running on the user system sets the DNS setting to 10.0.0.1. On the application exit, the DNS setting is set to DHCP.

In another embodiment, during installation, the user is prompted to select if the computing device will act as a gateway or not. Depending on the response, the appropriate drivers, software, and scripts are installed.

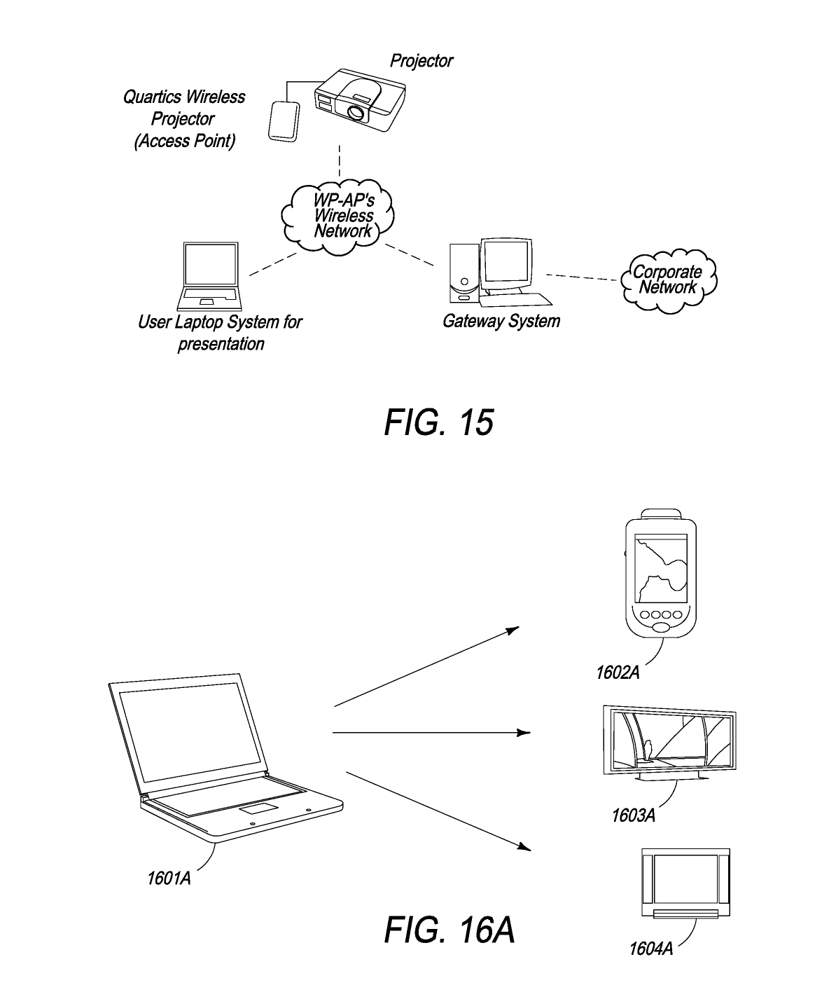

Referring now to FIG. 15, another exemplary configuration for automatically downloading and updating the software of the present invention is shown. The wireless projector access point has a pre-assigned IP Address of 10.A.B.1 and the gateway system has as a pre-assigned IP Address of 10.A.B.2 where A and B octets can be changed by the user.

The WP-AP is booted. The user's computing device scans for available wireless networks and selects QWPxxxxxx. The computing device's wireless configuration should have automatic TCP/IP configuration enabled, i.e. ‘Obtain an IP address automatically’ and ‘Obtain DNS server address automatically’ options should be checked. The computing device will automatically get an IP address from 10.0.0.3 to 10.0.0.254. The default gateway and DNS will be set as 10.0.0.1.

The user opens the browser, and, if Java is supported, the automatic software update begins. If Java is not supported, the user will be prompted to save the installation and will have to run it manually. If the computing device will not act as a gateway to a network, such as the Internet, during the installation, the user selects ‘No’ to the Gateway option.

The installation runs a script to set the DNS as 10.0.0.2. So that next DNS query gets appropriately directed. An application link is created on the desktop. The user runs the application that starts transmitting the exact contents of the user's screen to the Projector. If required, user can now change the WP-AP configuration (SSID, Channel, IP Address Settings: second and third octet can be changed of 10.0.0.x.).

If the computing device will act as a gateway to a network, such as the Internet, during the installation, the user selects ‘Yes’ to the Gateway option when prompted. The installation then enables Internet sharing (IP Forwarding) on the Ethernet interface (sharing is an option in the properties of network interface in both Windows 2000 and Windows XP), sets the system's wireless interface IP as 10.0.0.2, sets the system's wireless interface netmask as 255.255.255.0, and sets the system's wireless interface gateway as 10.0.0.1. An application link is created on the desktop. The user runs the application that starts transmitting the exact contents of the user's screen to the Projector. If required, user can now change the WP-AP configuration (SSID, Channel, IP Address Settings: second and third octet can be changed of 10.0.0.x.).

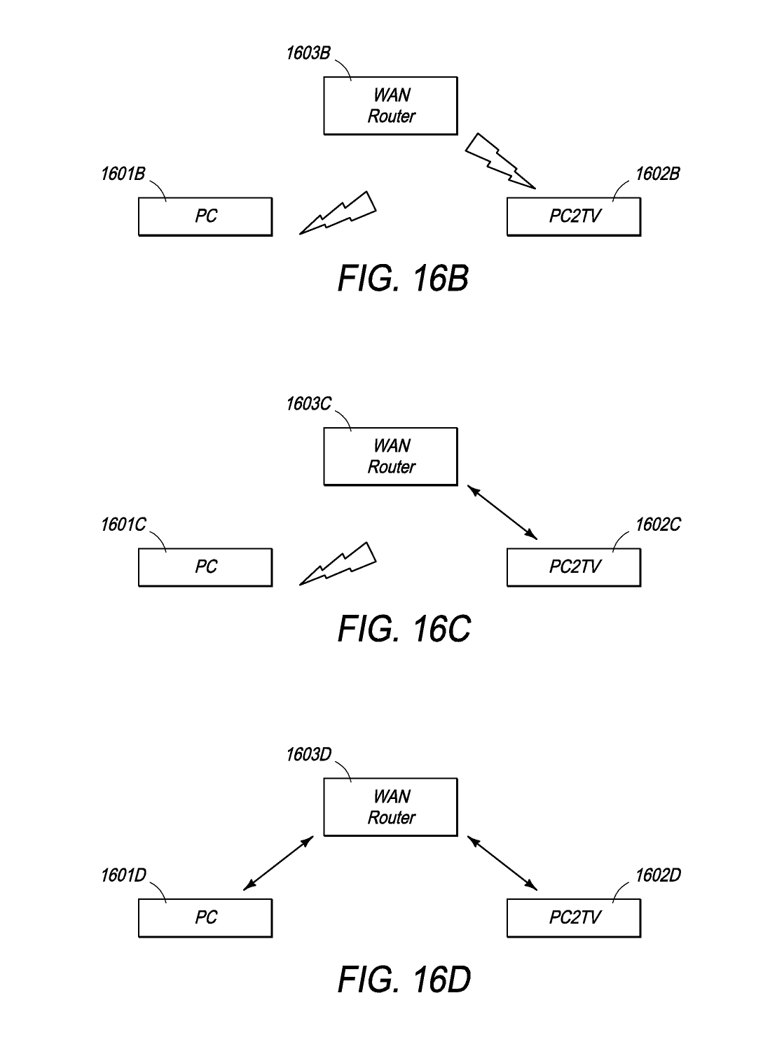

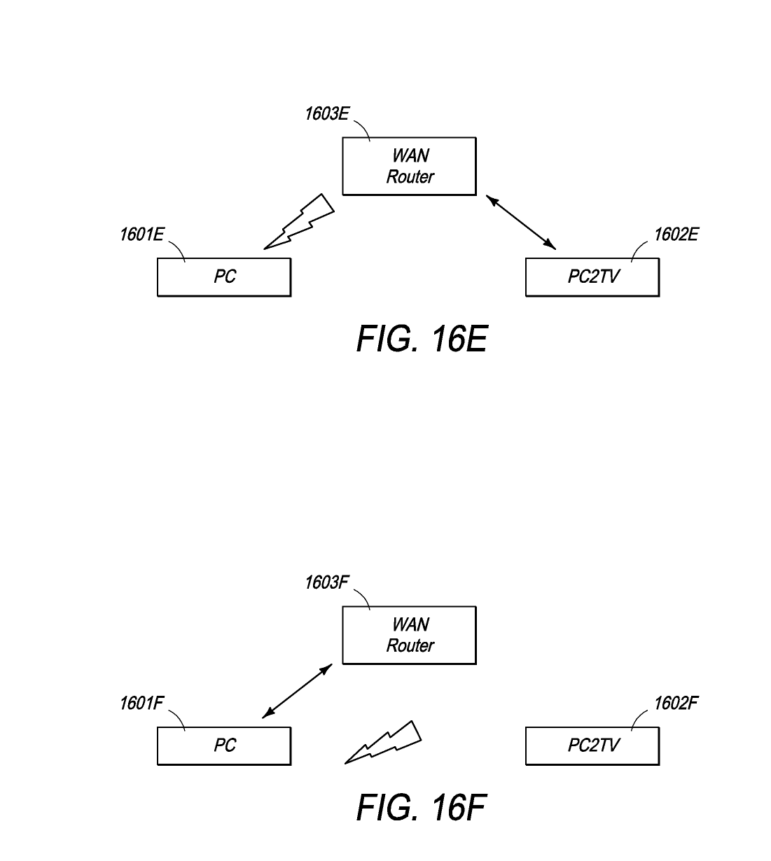

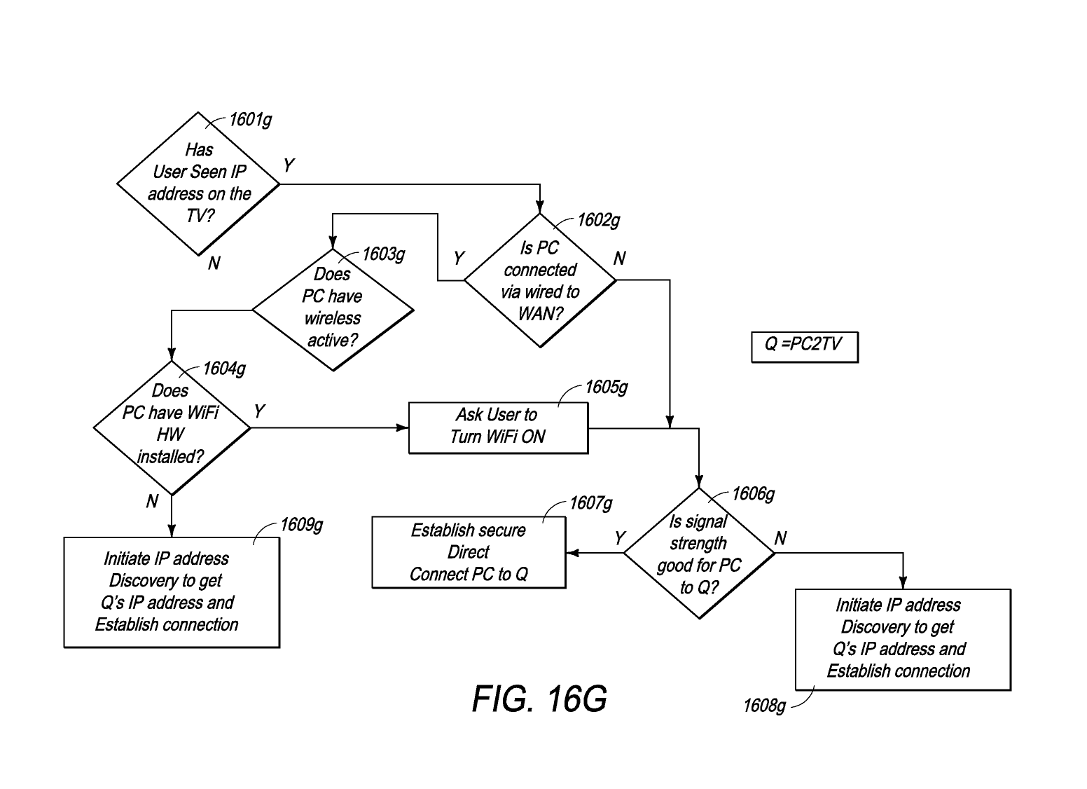

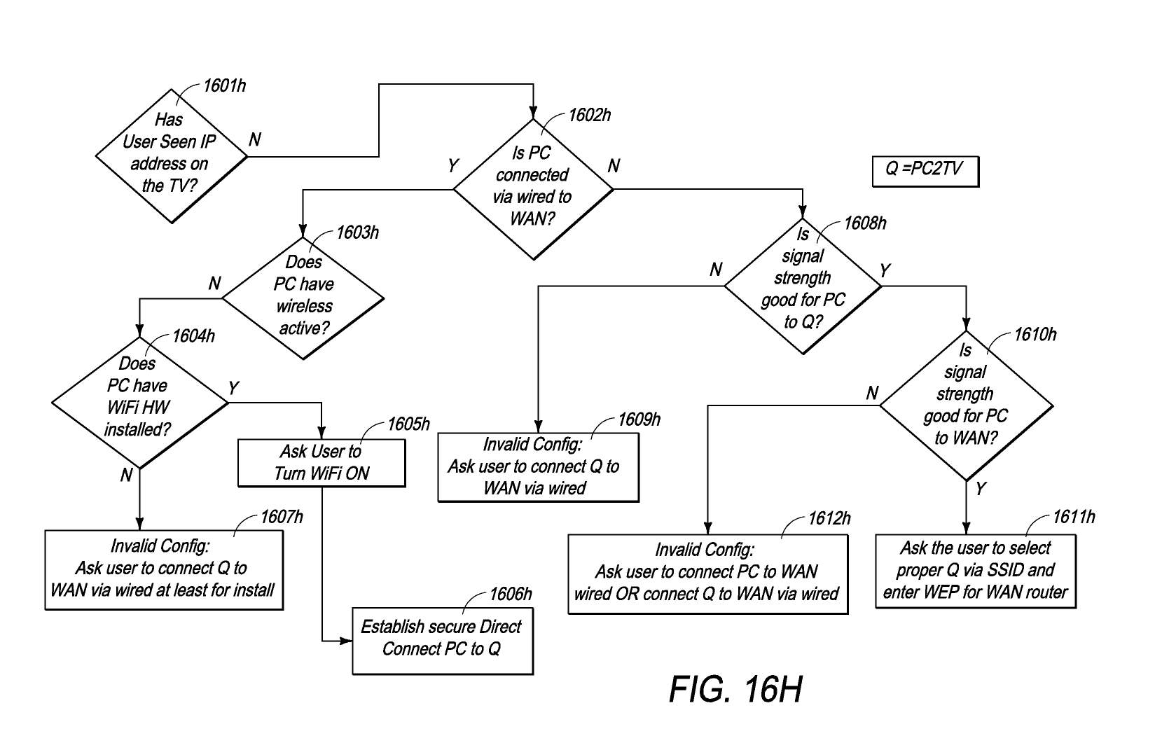

It should be appreciated that the present invention enables the real-time transmission of media from a computing device to one or more remote monitoring devices or other computing devices. Referring to FIG. 16a, another arrangement of the integrated wireless multimedia system of the present invention is depicted. In this particular embodiment the communication between the transmitter 1601a and the plurality of receivers 1602a, 1603a, 1604a is depicted. The transmitter 1601a wirelessly transmits the media to a receiver integrated into, or in data communication with, multiple devices 1601a, 1602a, and 1603a for real-time rendering. Devices 1601a, 1602a, and 1603a can be any type of electronic device, including set-top boxes, personal video recorders, or gaming device, such as Microsoft's Xbox™, Nintendo's Wii™, and Sony's PS3™. In an alternate embodiment the abovementioned software can also be used in both the mirror capture mode and the extended mode. In mirror capture mode, the real time streaming of the content takes place with the identical content being displayed both at the transmitter and the receiver end. However, in an extended mode, a user can work on some other application at the transmitter side and the transmission can continue as a backend process.

In yet another embodiment of the present invention, a PC2TV installer comprises a plurality of instructions which enables installation, setup and connection with minimum user intervention. The PC2TV installer is a specialized program, which automates the task required for installation. In operation, the PC2TV installer, which, when first obtained and saved on to the local hard drive of the computing device, is in condensed form, unpacks itself and provides relevant information to be placed correctly on the computer, taking into account the variations between computers, and any customized settings required by the user. During installation, various tests are made of system suitability, and the computer is configured to store the relevant files and settings required for PC2TV to operate correctly.

In another embodiment of the present invention, the installer provides various messages regarding the progress of the installation such as initializing set up files, installing wireless files, such as step five of ten in progress and installation complete. The various messages which are displayed on the computer help the user to know the status of the installation. In yet another embodiment of the present invention, the installer provides suggestions for alternative connections when required. At application launch, the robustness of the connection is checked and the user is alerted if the signal quality is not optimal. The user may then opt for the alternative connections available.

In yet another embodiment of the present invention, computing device such as personal computer (PC), remote monitor such as television (PC2TV) for rendering PC content, and wide area network (WAN) router are connected in a variety of configurations wirelessly or by wired networks. FIGS. 16b-f shows the various configurations in which PC, PC2TV and WAN Router can be connected.

In various embodiments of the present invention, the computing device can be a desktop, laptop, PDA, mobile telephone, gaming station, set-top box, satellite receiver, DVD player, personal video recorder. In another embodiment the satellite device and remote monitor can be a television, plasma display device, flat panel LCD, HDD, projector or any other electronic display device known in the art capable of rendering graphics, audio and video.

Operationally, the installer asks the user to enter what he sees on the satellite device screen i.e. Service Set Identifier (SSID) or IP address or both. Generally, SSIDs are case sensitive strings having a sequence of alphanumeric characters (letters or numbers) with a maximum length of 32 characters. In various embodiments of the present invention, the SSID on wireless clients can be set either manually, by entering the SSID into the client network settings, or automatically, by leaving the SSID unspecified or blank. Typically, a public SSID is set on the access point and is broadcasted to all wireless devices in range.

The installer then detects whether the computing device accesses a network through a wired or wireless access, and implements IP address discovery for the client. In various embodiments, the manual entry of IP address is avoided and an automatic entry of IP address is sought.

Once the IP address is located, the installer then enables the computing device to interrogate wireless signal strength available to a satellite device from a particular WAN router. In various embodiments of the present invention, both SSID and IP address is rendered on the satellite device screen. However if only SSID is rendered on the satellite device screen then the user is asked to establish wired connection from the WAN Router to the computing device or between the satellite device and the WAN Router. In another embodiment the system checks for a wireless adapter and uses the satellite device SSID to generate a security key and establish a secure connection.

In one embodiment of the present invention, the user is prompted to connect via power line networking. In power line networking, household electrical wiring is used as a transmission medium. Various standards, including but not limited to INSTEON, BPL, HomePlug Powerline Alliance and Universal Powerline Association, and X10 are utilized for power line communications. Typically power line communications devices operate by modulating in a carrier wave of between 20 and 200 kHz into the household wiring at the transmitter. The carrier is modulated by digital signals. Each receiver in the system has an address and can be individually commanded by the signals transmitted over the household wiring and decoded at the receiver. These devices may either be plugged into regular power outlets or may be permanently wired in place. Since the carrier signal may propagate to nearby homes (or apartments) on the same distribution system, these control schemes have a “house address” that designates the owner.

In another embodiment, Wired Equivalent Privacy (WEP) and IP address entry dialog boxes prompts the user to input the values. Wired Equivalent Privacy or Wireless Encryption Protocol (WEP) is a scheme to secure IEEE 802.11 wireless networks. It is part of the IEEE 802.11 wireless networking standard. In various embodiments of the present invention, a 128-bit WEP key is entered by a user as a string of 26 Hexadecimal (Hex) characters comprising of numbers 0-9 and characters A-F. The format of the IP address is similar to the above-mentioned examples.

Once a configuration is detected, it is shown graphically to the users that a connection has been established and the user is prompted to confirm. Upon confirmation the computing device transmits the media content to the satellite device.

Referring back to FIG. 16b-f, various configurations in which a PC (an exemplary computing device), PC2TV device (satellite device) and a WAN Router are connected both wired and wirelessly. FIG. 16b depicts the arrangement of PC 1601b, PC2TV 1602b and WAN Router 1603b in a wireless configuration. The WAN Router 1603b is wirelessly connected to PC2TV 1602b which is further connected to the PC 1601b wirelessly. The transfer of content in a wireless configuration takes place using appropriate wireless standards for the transmission of graphics, text, video and audio signals, for example, IEEE 802.11a, 802.11g, Bluetooth2.0, HomeRF 2.0, HiperLAN/2, and Ultra Wideband, among others, along with proprietary extensions to any of these standards.

FIG. 16c depicts another arrangement of a PC 1601c, PC2TV 1602c and WAN Router 1603c in a wired and wireless configuration. The PC2TV 1602C is connected to the WAN Router 1603C via wired line. The PC2TV 1602C is further connected to PC 1601C wirelessly.

FIG. 16d depicts one more arrangement of PC 1601d, PC2TV 1602d and WAN Router 1603d in a wired configuration. Both the PC 1601d and PC2TV 1602d communicate with WAN Router 1603d via wired line. Any media which is on PC 1601d and is destined to be rendered on PC2TV 1602d is communicated via the WAN Router 1603d.

FIG. 16e depicts the arrangement of PC 1601e, PC2TV 1602e and WAN Router 1603e in a wired configuration. The PC2TV 1602e is connected to the WAN Router 1603e via wired line and the PC 1601e is connected to the WAN Router wirelessly.

FIG. 16f depicts the arrangement of PC 1601f, PC2TV 1602f and WAN Router 1603f in a wired and wireless configuration. The WAN Router 1603f is connected to the PC2TV 1602f via wired line while the PC2TV 1602f is connected to the PC 1601f wirelessly.

FIG. 16g depicts an exemplary flowchart for automatic detection of PC2TV (exemplary satellite device), connected to the WAN router, via a PC (exemplary computing device). The installer ascertains 1601g whether the user has seen an IP address on the PC2TV. If an IP address is detected on PCTV, the installer determines 1602g whether the PC is connected to WAN via wired line. If the PC is connected to WAN via wired line, the installer determines 1603g whether the wireless capability of the PC is active. If the wireless capability of the PC is not active, the installer determines 1604g whether the hardware of the PC is WiFi enabled. If the PC is WiFi enabled, the user is prompted to turn ON 1605g the WiFi. Then the installer determines 1606g whether the signal strength is good enough for the PC to connect to the PC2TV device. If the signal strength is good, the installer secures 1607g a direct connection to establish between PC to PC2TV. If the signal strength is not good, the installer initiates 1608g an IP address search to obtain PC2TV's IP address and establishes a connection. If the PC is not WiFi enabled, the installer initiates 1609g an IP address discovery to find PC2TV IP address and to establish connection.

FIG. 16h is a flowchart for automatic detection of PC2TV (exemplary satellite device), connected to the WAN router wirelessly, via PC (computing device). The installer ascertains 1601h whether the user has seen an IP address on the PC2TV. If an IP address is not detected on PC2TV, the installer determines 1602h whether the PC is connected to the WAN via wired line.

If the PC is connected to WAN via wired line, the installer then determines 1603h whether the wireless capability of the PC is active. If the wireless capability of the PC is not active, the installer ascertains 1604h whether the WiFi hardware is installed. If the PC is WiFi enabled, the user is prompted to turn ON 1605h the WiFi. The installer then establishes 1606h secure direct connection between PC to PC2TV. In one embodiment, PC2TV SSID is used to generate security key and establish secure connection.

If the PC is not WiFi enabled, the user is informed that installation cannot be accomplished and is prompted 1607h to connect PC2TV to WAN via wired configuration for installation. In another embodiment, the user is prompted to temporarily connect using a power line adaptor.

If the PC is not connected to WAN via wired line, the installer ascertains 1608h if the signal strength is good from PC to PC2TV. If the signal strength is not good, user is informed that installation cannot be accomplished and the user is prompted 1609h to connect PC2TV to WAN via wired configuration. In another embodiment of the present invention user is recommended to install wireless booster or powerline network adapter for PC2TV.

If the signal strength is good, the installer then determines 1610h whether signal strength is also good for PC2TV to WAN. If the signal strength is good for PC2TV to WAN, the user is prompted 1611h to select appropriate PC2TV via SSID and enter WEP for WAN router.

If the signal strength is not good for PC2TV to WAN, the user is informed that installation cannot be accomplished and the user is prompted 1612h to connect PC to WAN via wired connection or to connect PC2TV to WAN via wired connection.

In one embodiment the software for wirelessly transmitting PC content to a television can be integrated with software for managing the media to be played, rendered, or otherwise depicted, as further discussed below.

### User Interface and Media Manipulation Features

The present application also enables a novel set of media manipulation features and user experiences. Preferably, these various features are implemented in the context of a media browser that enables users to search for, find, index, access, and view content of any type, including images, video, and audio. In another embodiment, these various features are implemented in the context of a utility application designed to integrate cellular content, such as media from cellular networks, local PC content, such as media from a local hard drive, or network accessible content, such as media from the Internet, with conventional satellite, cable, or broadcast TV content for display on a TV using any type of controller device, including the novel controller devices described below.

In another embodiment, the present application enables a paradigm of distributed processing, in which a user operates a central networked computing device having conventional processors, such as Intel's® Core™ 2 Duo, Pentium®, and Celeron® processors, and conventional operating system software, such as Microsoft's Windows® or Apple's Mac® software, and, separately and remotely, a plurality of satellite devices (mobile phone, displays, cameras, billboards, televisions, PDAs, and other electronic devices) having specialized processing that, through wireless network communication, substantially relies on the networked computing device as a central media access and processing hub.

Referring to FIG. 22, the software of the present invention preferably operates on at least the central networked computing device 2200 which is in wireless communication 2210 with a plurality of satellite devices, such as a cell phone or PDA 2205, television 2206, billboard 2203, display 2202, tablet PC 2204, and still or video camera 2201. The plurality of satellite devices preferably comprise a transceiver and specialized media processing chip that is capable of receiving compressed, encoded media from the central networked computing device, decompressing the media, decoding the media, rendering the media on a display, and receiving and transmitting control signals to direct the processing activities of the central networked computing device. In this manner, the plurality of satellite devices can be more economically manufactured because they do not require the general processing power of the central networked computing device, can use a less costly specialized media processing chip, and can readily access all of the software and hardware power of the central networked computing device without having to replicate that software or hardware on the satellite device. An exemplary specialized media processing chip is disclosed in PCT Application No. PCT/US06/00622, which is incorporated herein by reference.

It should also be appreciated that the methods and systems of the present invention enable very high quality video transmissions, preferably allowing for the transmission and reception of video in the range of 20 frames per second or above, and more preferably at least 24 to 30 frames per second.

Operationally, a user operates a satellite device, such as a mobile phone, tablet PC, remote control, or television display, and connects the satellite device through a wireless or wired connection to network, which, in turn, permits connection to the central networked computing device. Using controls associated with the satellite device, such as a touch screen, remote control, keyboard, mouse, input buttons, keypad, or joystick, the user inputs a plurality of controls, which are then communicated as control signals to the central networked computing device. Typically, the controls will instruct the central networked computing device to initiate an application, open files, acquire media, navigate to a particular network accessible content source, execute applications, or play media. Upon receiving those instructions, the central networked computing device executes, as instructed, and transmits the displayed content, in a manner as described herein, to the satellite device. The satellite device receives the transmitted content, renders it for viewing by the user, and receives further instructions from the user, which it communicates back to the central networked computing device.

The software which enables the aforementioned features and user experiences shall now be further described.

### Computing Device-to-Remote Display Recognition Capability

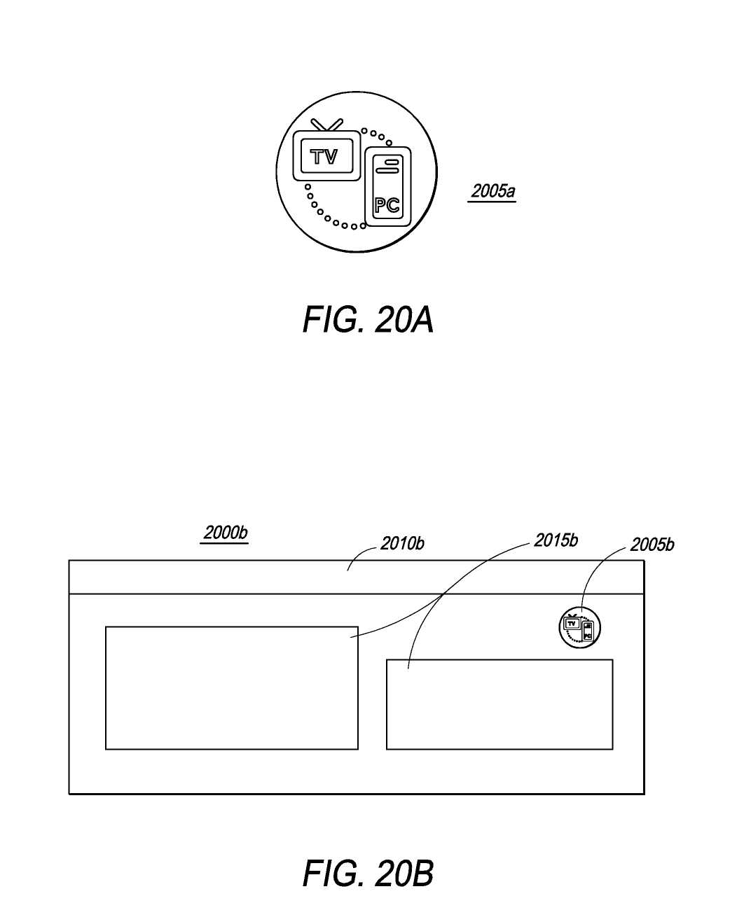

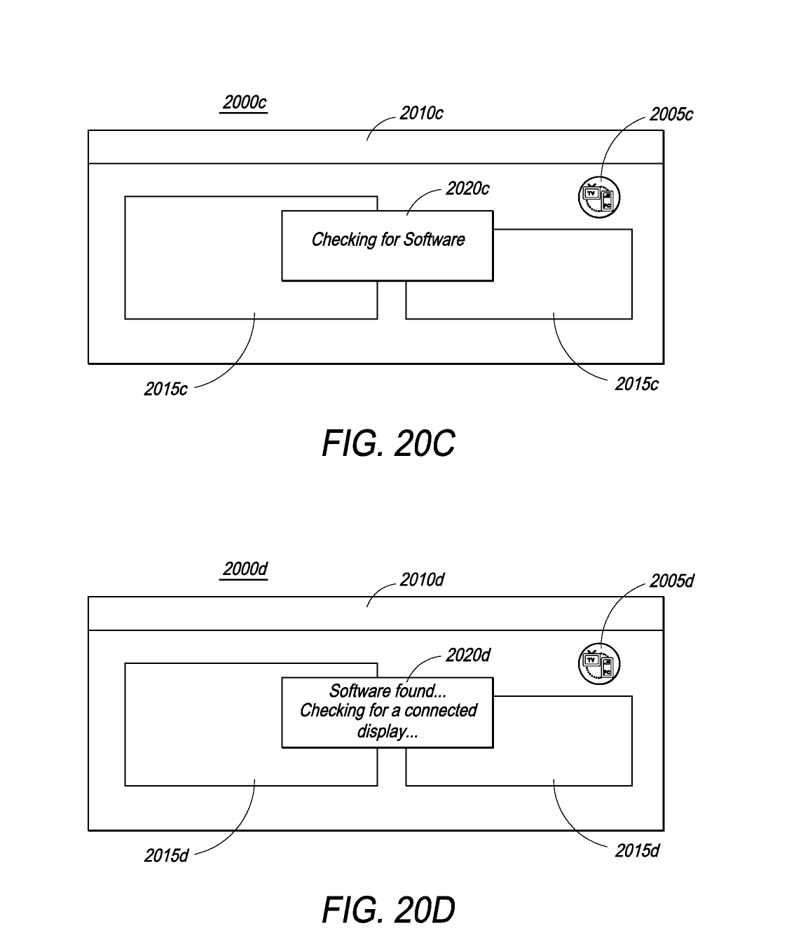

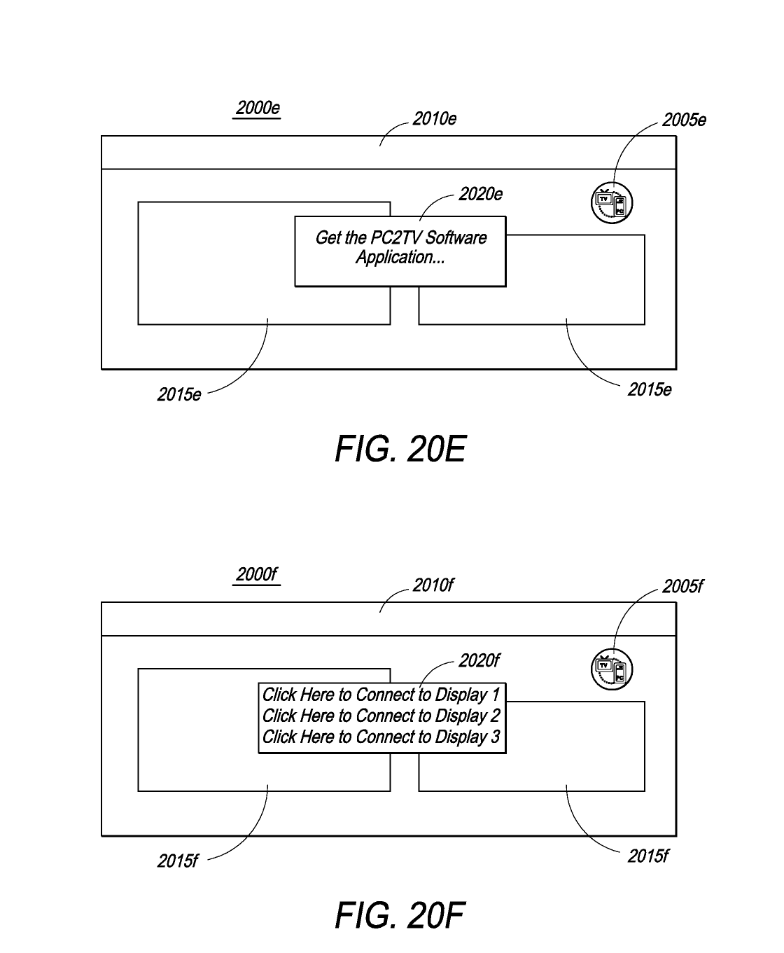

In one embodiment, the present invention provides a graphical user interface that integrates local computing device content or network accessible content and a remote display, such as a television display, by providing a specific icon that represents the “PC to Television” functionality, where the word “Television” is being generically used to refer to any remote display and “PC” is being generically used to refer to any computing device. Referring to FIG. 20a, an exemplary icon 2005a representing a “PC to Television” capability is presented (“PC2TV Icon”). The PC2TV Icon 2005a can be presented in any design or graphical format. The PC2TV Icon is designed to be integrated into any software application, including software for coding websites, operating systems, browsers, media players, or software that drives hardware devices, including remote controls, cell phones, keyboards, mouse controls, gaming systems, televisions, or personal computers.

Operationally, the PC2TV Icon 2005a is a user interface that, when engaged by a user, activates an underlying software application that has, or provides, the functionality described herein. The software application executes on the PC and is responsible for managing all of the following functions: a) identifying display devices capable of receiving a wireless transmission of media, b) offering a user the ability to select at least one of the identified devices, c) receiving a selection of a display from a user, c) causing the wireless transmission of media present on, or accessible through, a device displaying a button, such as a cell phone, PDA, personal computer, gaming console, or other device, to the selected display, and d) causing the media present on, or accessible through, the device to be properly formatted for display on the selected display. The media capture and transmission systems have been previously described above and will not be repeated here.

Referring to FIG. 20b, a conventional browser 2010b with a web page having a plurality of elements 2015b is depicted. Integrated into the webpage is a PC2TV Icon 2005b. As stated above, it should be appreciated that this is just one example of where a PC2TV Icon can be integrated. One of ordinary skill in the art would also appreciate that the PC2TV Icon 2005b is displayed by virtue of the webpage incorporating the appropriate HTML, or other code, such that, when a computing device receives the code, the associated display renders the PC2TV Icon 2005b visible to a user.

Referring to FIG. 20c, when a user interacts with the PC2TV Icon 2005c by, for example, clicking on it, the computing device is instructed to search for, and if identified, launch a software application comprising the present invention. In particular, the computing device searches for an application that can identify display devices capable of receiving a wireless transmission of media, offer a user the ability to select at least one of the identified devices, receive a selection of a display from a user, cause the wireless transmission of media present on, or accessible through, the computing device, and/or cause the media present on, or accessible through, the computing device to be properly formatted for display on the selected display. In the process of doing so, a window 2020c informing the user that the requisite application is being searched for is displayed in conjunction with the conventional browser 2010c with a web page having a plurality of elements 2015c. The PC2TV Icon 2005c can optionally continue to be displayed or be grayed out, preventing further user interaction.

In one embodiment, if a software application comprising the present invention is identified, it is automatically launched for use by the user. In another embodiment, if a software application comprising the present invention is identified, the computing device is automatically instructed to check for the presence of a display device that is in data communication with the computing device. The computing device preferably uses the functionality of the present invention to determine whether a display is in data communication with the computing device, as further discussed herein. Accordingly, as shown in FIG. 20d, a window 2020d informing the user that the requisite application has been found and a connected display is being searched for is displayed in conjunction with the conventional browser 2010d with a web page having a plurality of elements 2015d. The PC2TV Icon 2005d can optionally continue to be displayed or be grayed out, preventing further user interaction.

In one embodiment, if a software application comprising the present invention is not identified, another window is launched offering the user an opportunity to acquire the requisite application. Accordingly, as shown in FIG. 20e, a window 2020e offering the user an opportunity to purchase, download, acquire, or otherwise access the requisite application is displayed in conjunction with the conventional browser 2010e with a web page having a plurality of elements 2015e. The PC2TV Icon 2005e can optionally continue to be displayed or be grayed out, preventing further user interaction.

Referring to FIG. 20f, if a software application comprising the present invention is identified and at least one connected display is identified, a window is displayed that informs a user that a connected display has been found and provides the user with an option to direct the display of the computing device, or other media, to the connected display by, for example, clicking on an icon. Optionally, if there is more than one connected display identified, a window is displayed that informs a user that more than one connected display has been found and provides the user with an option to direct the display of the computing device, or other media, to at least one of the connected displays by, for example, clicking on the appropriate icon. Accordingly, as shown in FIG. 20f, a window 2020f informing the user that connected displays have been found and can be accessed by clicking on an appropriate link is displayed in conjunction with the conventional browser 2010f with a web page having a plurality of elements 2015f. The PC2TV Icon 2005f can optionally continue to be displayed, be grayed out, preventing further user interaction, or flash, change in color, or otherwise be modified to indicate active PC to TV data communication.

The aforementioned process enables the originator of the webpage or other graphical user interface, i.e. a networked-based media source that offers access to media via a client-server or peer to peer application architecture, to know the type, functionality, and/or capability of one or more connected displays. In one embodiment, certain details describing the type of display are communicated to the computing device by the connected display, or are inputted into the computing device by the user. During the aforementioned interaction process, a user's interaction with a PC2TV Icon causes a computing device to identify the existence of a software application comprising the present invention and determine the availability of a connected display. Upon selecting the desired display to which to connect, the computing device can send a signal back to the computer or server hosting the application with the PC2TV Icon. That signal can comprise data encoding one or more of the following: a) whether a display has been successfully connected (binary state), b) the manufacturer of the display (e.g. Sony, Phillips, etc.), c) the size of the display (e.g., 19″, 46″, etc.), d) the maximum resolution of the display, and e) whether the display can receive certain signal formats, such as high-definition signals.

There are numerous benefits to being able to communicate to a networked-based media source the nature of the display being used. As discussed below, with knowledge of the nature of the display, a networked-based media source can optimize the media being delivered, and associated advertising, for the connected display. For example, if the display is large, HDTV ready television, the networked-based media source can choose to transmit a high definition media stream. If the display is smaller or not high definition, the networked-based media source can choose to transmit a lower resolution media stream, thereby conserving bandwidth. Furthermore, if the display is above a threshold size, the networked-based media source can choose to transmit a plurality of content streams that optimally use the entirety of the display “real estate”, rather than transmit a smaller amount of content more suitable for a smaller display. Similarly, if the display is below a threshold size, the networked-based media source can choose to select a subset of content streams to optimally make use of a smaller display, rather than transmit the entire amount of content and crowd the smaller display. This feature is discussed in greater detail below in relation to Dynamic Content Selection and Overlay.

Preferably, when a user navigates to a new network-based media source, he need not interact with another PC2TV Icon and repeat the process. Rather, upon navigating to a new network-based media source, the computing device transmits a signal to the network-based media source that, in a predesignated format, communicates a signal that comprises data encoding one or more of the following: a) whether a display is connected (binary state), b) the manufacturer of the display (e.g. Sony, Phillips, etc.), c) the size of the display (e.g., 19″, 46″, etc.), d) the maximum resolution of the display, and e) whether the display can receive certain signal formats, such as high-definition signals. Alternatively, the computing device can save a file containing data encoding one or more of the following: a) whether a display is connected (binary state), b) the manufacturer of the display (e.g. Sony, Phillips, etc.), c) the size of the display (e.g., 19″, 46″, etc.), d) the maximum resolution of the display, and e) whether the display can receive certain signal formats, such as high-definition signals. That file can be a generic file that is accessible to any inquiring application or a protected file that can only be accessed by a network service having specific permissions.

### Display Manipulation and Content Formatting

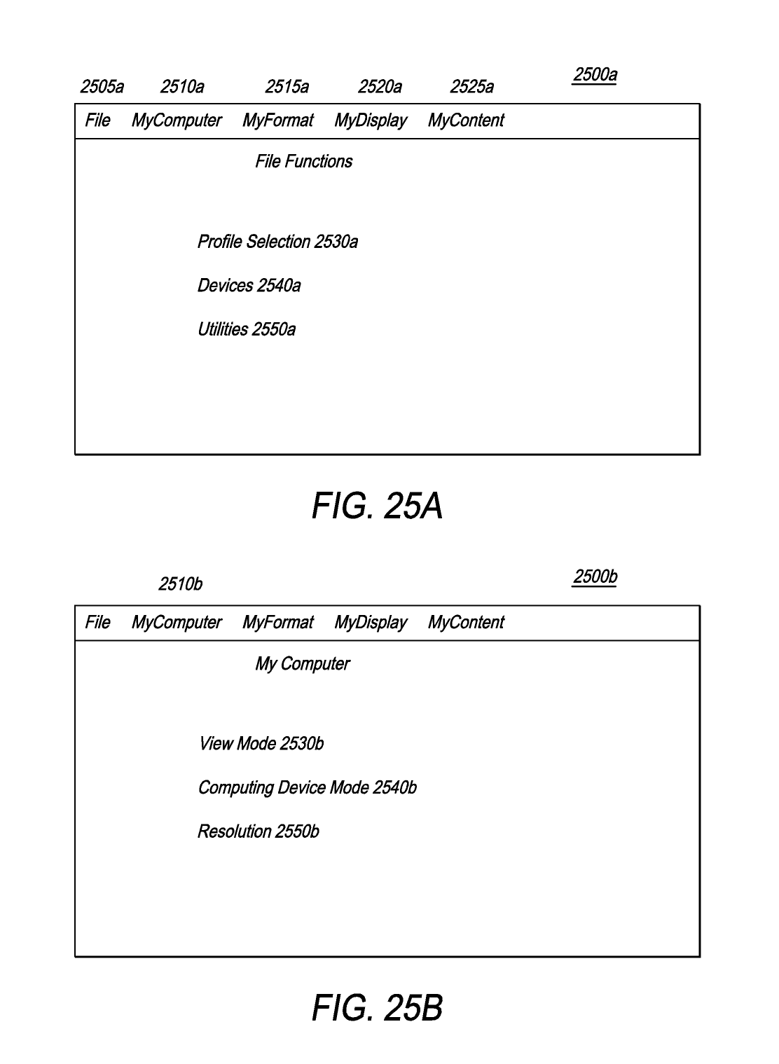

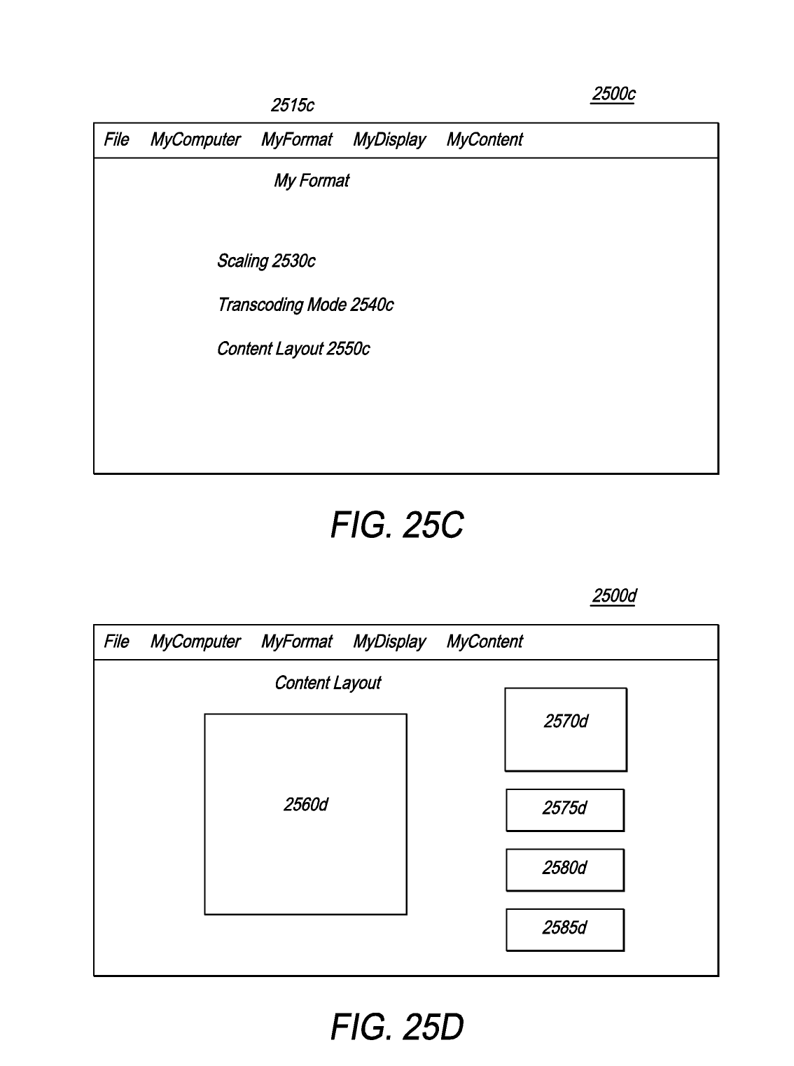

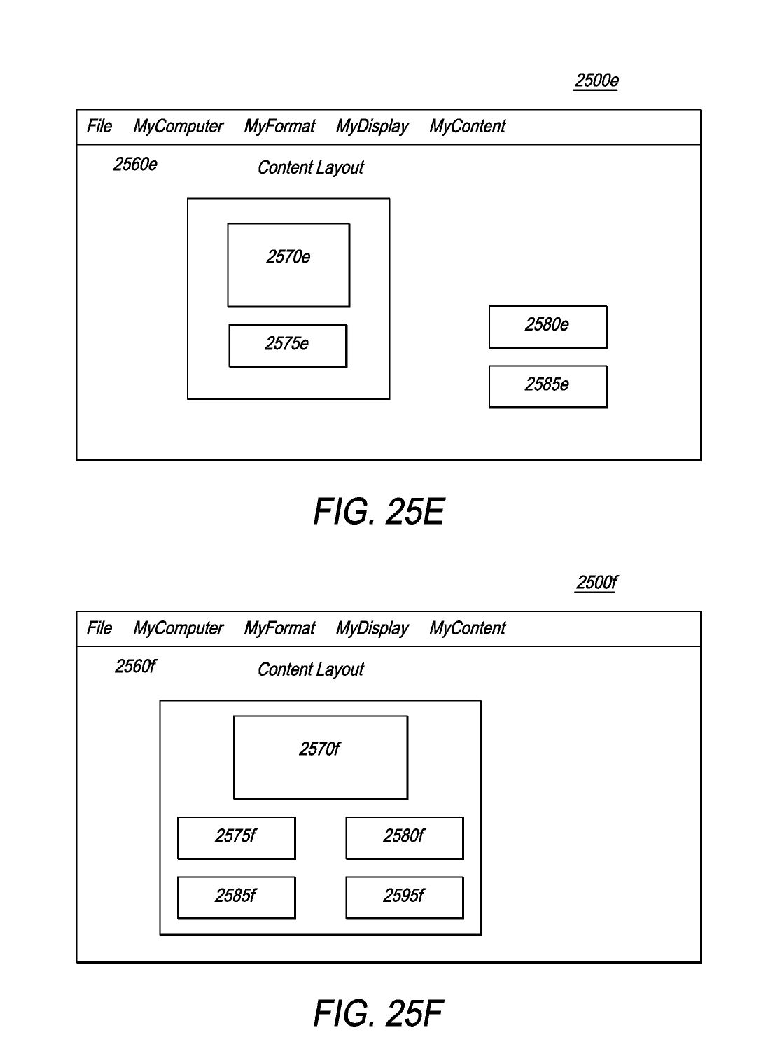

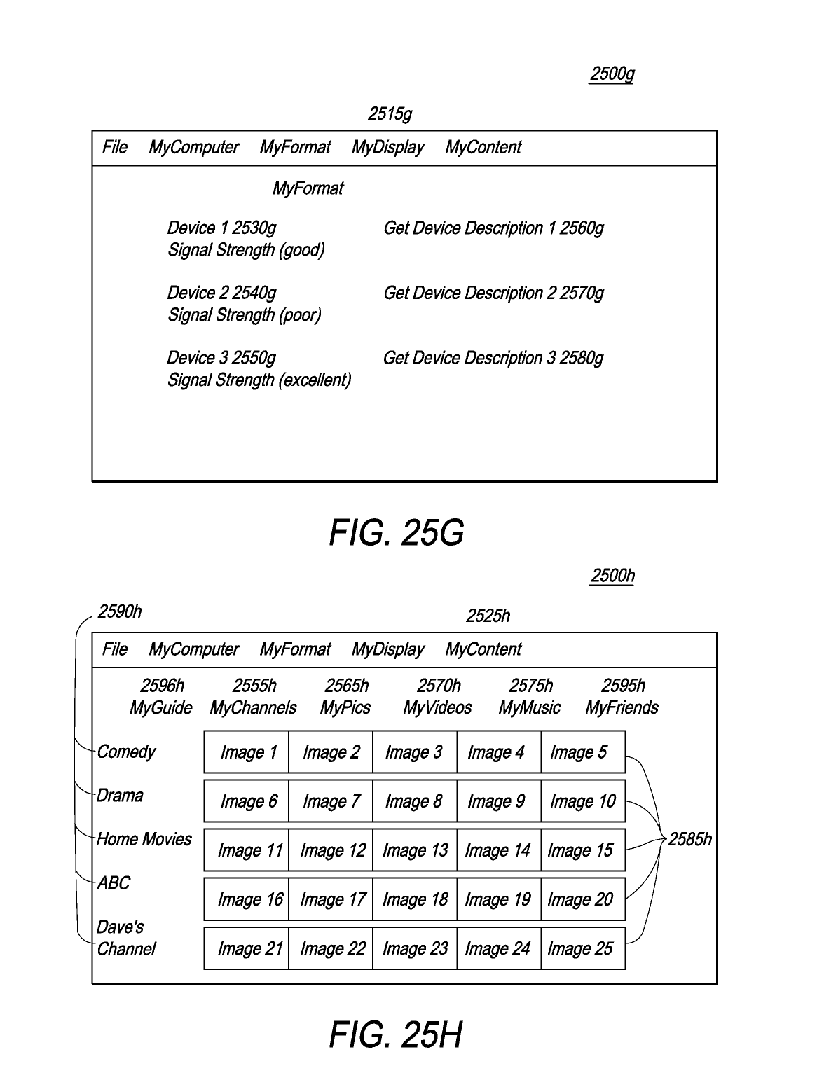

A software application comprising at least one embodiment of the present invention comprises a plurality of functions to enable the transmission of media by the computing device and optimally format the media transmitted for a specific display. Referring to FIG. 25a, the application 2500a generally includes a File set of functions 2505a, a MyComputer set of functions 2510a, a MyFormat set of functions 2515a, a MyDisplay set of functions 2520a, and a MyContent set of functions 2525a.

Referring to FIG. 25a, the File set of functions 2505a comprises profile selection capability 2530a, a device selection capability 2540a, and a general utilities 2550a capability. The profile selection feature 2530a comprises a plurality of instructions for directing the computing device to save the features defined in the MyComputer 2510a, MyFormat 2515a, MyDisplay 2520a, and MyContent 2525a menus as being specific to a particular user. The user can define a password, login, and a set of preferences which, when the user logs in to the software (either via the central networked computing device or satellite device), are automatically set by virtue of their association with the user's password and login information.

The devices feature 2540 comprises a plurality of instructions for directing the computing device to save the features defined in the MyComputer 2510a, MyFormat 2515a, MyDisplay 2520a, and MyContent 2525a menus as being specific to a particular device. For example, the software of the present invention can be programmed to recall a specific set of parameters, associated with the MyComputer 2510a, MyFormat 2515a, MyDisplay 2520a, and MyContent 2525a menus, whenever a specific device, such as a tablet PC, display, television, PDA, or cell phone, communicates with the central networked computer. A satellite device may communicate its identity to the software by a user input, where a user is presented, via the software communicating device options to the satellite device screen, a list of device options and selects the appropriate device or automatically by receiving an identifier associated with the satellite device.

In one embodiment, the specific set of parameters associated with an individual device includes parameters specific to a cell phone. The parameters which can be tailored include visual layout of the screen when media is retrieved, where video transmissions will be located and their relative size, what data streams to include, whether advertising should be included or eliminated, the options available to a user when accessing the central computing device from the mobile phone, among other features.

Referring to FIG. 25b, the MyComputer set of functions 2510b include, but are not limited to, operating a PC in extended view mode, adjusting when the computing device can go into sleep, shut down, restart, or hibernate modes, and modifying the resolution of the computing device. The view mode feature 2530b comprises a plurality of instructions for directing the computing device to communicate the visible display of the computing device, such that the visible display is directly replicated on the screen of the satellite device (non-extended view mode) or for directing the computing device to communicate a non-visible display area to the screen of the computing device, such that the visible display of the computing device is not replicated on the screen of the satellite device (extended view mode). Both modes are enabled by the software communicating the desired operational mode to the underlying computer operating system, or computer operating system components.

The central networked computing mode feature 2540b can be used to control the state of the central networked computing device, including whether it is active, asleep, in hibernation, shut down, or restarting. The active state is controlled by the software communicating the desired state to the underlying computing device operating system, or computing device operating system components. By this feature, the satellite device can readily ensure that the central network computing device does not hibernate or shut down while the satellite device is relying on the computing device for processing functions. Conversely, when the user is done using the satellite device, the satellite device can ensure that the central network computing device hibernates or shut downs. Finally, the resolution feature 2550b can be used to control the resolution of the central networked computing device. By this feature, the satellite device can readily modify the resolution of the central networked computing device.

Referring to FIG. 25c, the MyFormat set of functions 2515c include, but are not limited to, scaling media displayed on a computing device for the connected display (Scaling 2530c), automatically optimizing the encoding and decoding of the media (based, for example, on whether the content is video or graphics) (Transcoding 2540c), and modifying the content, relative to what is received from the network-based media source or what is shown on the computing device, for optimal display (Content Layout 2550c).

Regarding the scaling feature 2530c, in one embodiment, when the software application of the present invention transmits computer data to be displayed on a television, it automatically scales the image to account for the difference in resolution and the screen size of a computing device monitor and a television or a satellite device. This feature is enabled by receiving an input from the user, a network-accessible source, or display, regarding the size and other parameters of the display and then based on that input, scaling images to appropriately fit on that television.

In one embodiment, the software application prompts the user for information about the television screen size as soon as data is ready to be transmitted from the computing device to TV or satellite device. In another embodiment, the software derives the size, dimensions, resolution, or other details of the display from the display device. Preferably, the transceiver connected to, or integrated into, the satellite device is programmed with, or has access to memory that stores, data defining certain attributes of the television. Those attributes include, but are not limited to, screen size, screen dimensions, resolution, television type, manufacturer type, and display formats supported. The transceiver communicates that television attribute information to the software executing on the computing device. In another embodiment, the central networked computing device receives an initial description of the satellite device from the satellite device and then accesses a third party network accessible information source for details on how best to format.

In another embodiment, the present invention captures the video buffer at a resolution that is same as the computing device's resolution (mirror driver) or the extended screen resolution (extended driver). The satellite device (television or other device) communicates a display resolution setting, via any network including over IP, to the computing device executing the plurality of instructions that comprise the present invention. This information may be communicated by a hardware component attached to the satellite device or a programmatic module executing in the satellite device. A scaling module executing on the computing device then scales images to be output to the satellite device during the capture and color-space conversion (RGB to YUV) phases, thereby performing the processing at the output rate and minimizing processing.

Where the media being captured and displayed is a video embedded within a larger interface, such as a web page, only the video portion of the capture interface can be scaled. The present invention performs the selective scaling of media within an interface or selective scaling of a portion of an interface by a) identifying the areas of the interface to be selectively scaled, e.g. the video area embedded within the interface, b) identifying diametrically opposite corners of the area to be selectively scaled, e.g. the corners of the video area, and c) applying the scaling module to the area defined by the diametrically opposite corners. Where an embedded video is being selectively scaled, the video region is identified by monitoring the data rate change between consecutive frames and determining the area of the interface that has a data rate change typical of video. That area is then defined by identifying the corners.

Regarding the transcoding feature 2540c, in another embodiment, the present invention comprises a plurality of instructions capable of instructing a computing device how to optimally transcode media for wireless transmission depending on whether the media is primarily comprised of graphics or primarily comprised of video. In one embodiment, an embodiment of the present invention has, as a default, transcoding settings optimized for graphics. The default setting automatically changes to transcoding settings optimized for video when a detection module detects a data rate change between consecutive frames. If the detected data rate change is typical of video, the detection module instructs the transcoding module to adopt settings optimal for video processing.

Regarding the content layout feature 2530c, it comprises a plurality of instructions for modifying the transmission, and layout, of content based upon the screen size, screen resolution, format compatibility and other features of a satellite device. Data representative of the screen size, screen resolution, format compatibility and other features of a satellite device can be input into the software directly by the user, can be obtained directly from the satellite device, or can be obtained by transmitting an inquiry to a network accessible server having such information. Where the data is obtained from a network accessible server, the software can optionally give a user the ability to select his/her satellite device from a list of available options. Upon selecting the appropriate satellite device, data representative of the screen size, screen resolution, format compatibility and other features of a satellite device is communicated from the server to the software application.

Referring to FIG. 25d and interface 2500d, once the screen size, and other capabilities, of a satellite device is known, an interface can be presented to the user which will permit the user the ability to graphically define how the content, sourced from the central networked computing device, will appear on the screen of the satellite device. A graphical presentation of the satellite device is depicted 2560d, together with categories of content, such as the key content being accessed (news story, video, graphic) 2570d, key advertising 2575d, associated links 2580d, and optional advertising 2585d. Certain of the categories can be required, such as the key content and key advertising, while others can be optional. The required categories must be placed on the graphical representation of the screen for the software program to deem the configuration of the content layout to be complete and save the configuration.

An example of a completed layout for a cell phone is provided in FIG. 25e and interface 2500e. Here, the graphical representation of the satellite device screen 2560e comprises a key content stream 2570e and key advertising 2575e stream. The other streams 2580e, 2585e are not included. Referring to FIG. 25f and interface 2500f, an example of a completed layout for a 46″ display is provided. Here, the graphical representation of the satellite device screen 2560f comprises a key content stream 2570f, a key advertising 2575f stream, an associated links stream 2580f, an optional advertising stream 2585f, and a real-time chat screen 2595f that displays real-time chats being communicated in association with the content being accessed.

The MyDisplay set of functions 2520a include, but are not limited to, selecting the appropriate display and getting/inputting the appropriate device details. In one embodiment, the present invention detects connected devices, as previously described, and displays those devices, together with the detected signal strength. Here, three devices are depicted, 2530g, 2540g, and 2550g. A user can choose to select one or more of the devices with which to establish data communication. A user can also initiate the collection of device data, as previously described, by clicking on the appropriate Get Device Description interface link 2560g, 2570g, and 2580g.

The MyContent set of functions 2525h include, but are not limited to, a) a graphical user interface capable of formatting media, obtained from any source, into channels, categories, or any other formatting construct, b) a graphical user interface enabling the manipulation of a content stream for pausing, recording, stopping, forwarding, or reversing, c) a module for sharing selected media by emailing, posting, or other communication methods, d) advertisement modules capable of inserting, manipulating, modifying, or otherwise providing advertisements in association with media, e) a user monitoring module capable of monitoring media usage, and f) an electronic program guide.

Referring to FIG. 25h, in one embodiment, the present invention provides a graphical user interface 2500h with a plurality of menus, including MyGuide 2596h, MyChannels 2555h, MyPics 2565h, MyMusic 2575h, MyVideos 2570h, and MyFriends 2595h. The MyChannels 2555h interface comprises a plurality of channels 2590h, each having a specific description, such as comedy or drama, or a specific content source, such as ABC or Dave's Channel. The channel descriptions can be established by the user or broadcast by content sources and subscribed by the user. Within each channel, along an x axis, is an image 2585h representative of a piece of video, graphical, textual, or auditory content available in, and associated with, that channel.

In one embodiment, channels are populated using representative screen shots of pieces of media fitting the channel description. The software application identifies and selects pieces of media by cataloging content on websites providing RSS feeds as well as other websites. FIG. 24 illustrates a method for accessing and presenting RSS feeds using an example of a news website. Referring to FIG. 24, the software application 2405 aggregates a plurality of RSS feeds 2415, 2425, 2435 which are created and made available by a content source 2445. The software application of the present invention aggregates the RSS feeds and assigns the feeds to a channel based on their metadata, thereby presenting the RSS feeds in a format suitable for channel-based viewing.

In case the software application of the present invention accesses websites without RSS feeds, then based on associated data, it presents the website as a video stream by framing the site or simply displaying the site without a frame or modification.

In another embodiment, the software application is able to search desktop, or any identified memory source, for pre-designated content that may include pictures, video, or audio and classify this content to be displayed in different channels under the MyPics 2565h, MyVideos 2570h, and MyMusic 2575h menu options.

The MyFriends 2595h menu option provides a plurality of options enabling a user to communicate with third parties. In one application of streaming PC content with television programs, users may be able to post their comments regarding specific television programs on a website. These comments may then be displayed along with the associated television programs on a real-time basis, that is, whenever those television programs are aired. In one embodiment, the comments may be streamed as a running banner on the bottom of the screen, in a manner similar to breaking news, headlines or other information being displayed on news channels. As previously discussed, a user can format the satellite device presentation to include these optional data streams.

In one embodiment, the software application running on the computing device includes a module that enables automatic delivery of user-specified broadband content on certain regions of the satellite device screen. Further the two dimensional remote control for integrated TV and PC content viewing, as discussed below, may be provided with a button that when clicked, delivers a pre-designated chat room, blog, or blog stream. Thus, a viewer may be able to customize the internet content being streamed along with any network accessible media.

Since the system of present invention uses IP-enabled devices such as cable or satellite set top boxes to transmit content to the television screen from a computing device, the system can be used to provide integrated viewing of the two feeds, that is, television broadcast programs and PC content can be viewed simultaneously. Therefore, it should be appreciated that any network accessible content from the central network computer can be acquired and overlaid on a display. A window on the television screen is dedicated to viewing network accessible content and overlaid on television content, which is displayed in a separate window on the television screen. The use of one or more windows to display separate channels on a single screen is well known in the art, and the same can be extended to simultaneous viewing of PC/network accessible and TV content.

As mentioned previously, one embodiment of the present invention works by updating the IP-enabled device, also referred to as a satellite device, connected to the television with software that allows it to communicate with a PC. This software at the IP-enabled device can be configured to send information to the PC, with the details of program being watched on TV. This information can be in turn utilized by the software application running on the PC to determine content relevant to the TV program. Thus, if a viewer is watching a popular program on TV, he may be able to chat about the program with other people over the Internet, may receive information regarding products relevant to the program and may be able to access links to any websites related to the program content. All this information may be made available to the user in different windows or regions on his TV screen by the software application running on the PC.

Alternatively, where the central network computer is transmitting media to a specific television video channel, i.e. video input one, and the television receives conventional cable, satellite, DVD, or broadcast data on different video channels, i.e. video inputs 2-6, software on a television receiver, such as the cable or satellite box, communicates the metadata describing the program being displayed the selected video input to the central networked computing device. Alternatively, a user may directly inform the central networked computing device as to what is being displayed in the selected video input.

Thus for example, if a viewer is watching CNN through satellite or cable TV, the software in his IP-enabled set top box can transmit this information, or metadata describing this information, to the PC. The software application at the PC in turn searches the internet for content related to the described CNN program. Such content may, for example include blogs about CNN, product advertisements that can be displayed along with the program, and even interactive services such providing feedback to the channel via e-mail. All this Internet content may be displayed by overlaying on the viewer's TV screen in separate windows.

The functionality of searching and displaying content relevant to a broadcast program can be achieved by taking the TV program description, or metadata, transmitting that information to a relational database, and looking up products, sites, services, relevant to the program. Optionally, a publicly available database of TV programs or an online TV program guide may be created, which allows any person to associate their blog, website, or chat room with a program of their choice. Thereafter, these listings may be sorted based on popularity and displayed appropriately. Again, any network accessible content, including videos, graphics, text, audio, blogs, chat rooms, email inboxes, podcasts, commercial websites, and peer to peer applications, can be searched for (using metadata, user input, or other information) by the central networked computing device, acquired by the central networked computing device, and transmitted to a display. Where the display is integrated with other content networks, such as a television with a cable, antenna, or satellite receiver, the network accessible content can be concurrently displayed, in one window, with content from the other content networks.

In another application, under the MyGuide menu option 2596h, a “Broadband Guide” may be displayed on one of the channels or by overlaying on the satellite device screen, along with the Electronic Program Guide (EPG) for television programs. The “Broadband Guide” details the internet content such as websites, blogs or chat rooms relevant to the programs listed in the EPG. The on-screen interface may also be optionally equipped with other features such as setting specific channels as favorites, search and filter mechanism to allow users to search for specific titles or actors, with the results being displayed as visual images, child lock, fast forward, rewind, pause, record, and parental control. Electronic program guides known in the art can be integrated herein. Content control functionality is also known in the art and can be integrated herein.

Advertising from the Internet relevant to Internet, cable, satellite, or broadcast programs may also be streamed from the central networked computing device, thereby enabling a new and powerful source of income for Internet sites. In one embodiment, where an Internet site becomes “aware” of the display type and size being used by the user, as previously discussed, the Internet site can communicate, in a separate stream, advertising specifically designed for a display of that particular type. For example, the Internet site can transmit additional, higher resolution banners, which are not necessarily received by just navigating to the website, to the accessing central networked computing device. The additional, higher resolution banners are designed to use the additional display “real estate” and to take advantage of the improved resolution of the display. Therefore, the Internet site is able to augment the display of its conventional website by transmitting independent, separate, or additional data catered to the user's display type and size.

In that light, the software application of the present invention is provided with a module to manage advertising space on a television. The application provides a predefined interface for receiving the independent, separate, or additional data catered to the user's display type and size. As previously discussed, the present application can inform the Internet site of characteristics defining the user's display. With that information, the Internet site can determine whether to transmit independent, separate, or additional data catered to the user's display type and size. If so, it formats and transmits that data, in accordance with the application's predefined interface. The application receives the data and overlays the data on regions in the display, which concurrent displays the Internet site's conventional site.

In another embodiment, the software application comprises a module that allows content owners to share content and associate with that content available advertising segments. The available advertising segments can be posted for purchase on any network accessible site, such as an online auction website like eBay.

In one embodiment, content owners may develop content and post it for viewing on a third party site. Because the present invention enables a user to access any network accessible content and transmit it to a display for viewing, it has the capability of inserting any other content, such as advertising, in the data stream being transmitted from the central networked computing device. In particular, data representative of the data being displayed on the central networked computing device can be integrated with, or concurrently transmitted with, data from other sources, such as network data streams representative of third party advertising. Therefore, the displayed data on the central networked computing device is augmented with additional data and both the displayed data on the central networked computing device and additional data is displayed on the satellite device.

To enable the appropriate matching of the data displayed on the central networked computing device with network accessible data streams representative of third party advertising, one embodiment of the present application enables users to specify parameters such as allowable subject matter, resolution, length of time, prohibited subject matter, cost, prohibited parties, allowed parties, and size for network accessible data streams representative of third party advertising. Third parties, namely advertisement buyers, may then communicate an advertisement, possibly directly to a user or mediated via a third party website, to the content owner, who can then evaluate each offer or automatically grant advertising space to a third party based upon predefined parameters.

The third party may then provide the advertisement that satisfies the requirements specified by a content owner as a data stream to be integrated into the display stream by, for example, posting the file to a third party site or making it available on a private, secure site via a link. Thereafter the winning advertisement can be catalogued in an online database as having an advertising that should be played along with the content, meeting certain criteria, from the central networked computing device. Thus, whenever any content is selected from the Internet for playing, the advertising module of the present invention examines the metadata of the content stream, searches the online advertising database for appropriate advertisements that should be played along with the content, allocates time during the content for playing the advertisements, integrates the two data streams in accordance with the time allocation, and plays the advertisements at the predetermined time.

Alternatively, the advertisement buyer may simply provide a link to his or her advertisement and associate parameters with the advertisement. Whenever content matching those parameters are met, the advertising module obtains the advertisement using the provided link and plays it along with the content in one of the regions of the satellite device. In any case, the advertisement buyer may be charged on a per-play basis, a fixed rate basis, or a per-play basis with a ceiling on total fees.

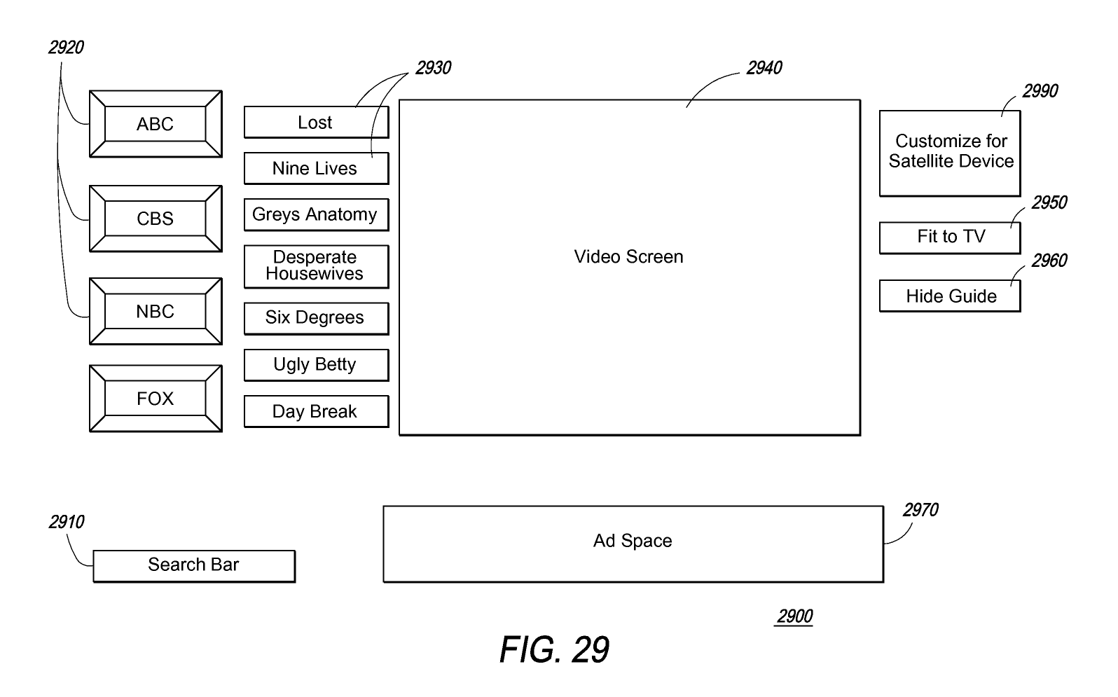

Another embodiment of an exemplary user interface 2900 is provided in FIG. 29. It should be appreciated that this interface is designed to be displayed both on the networked computing device and the satellite device, including a display such as a television. A plurality of channels 2920 is provided on the left side of the interface 2900. Depending on the channel chosen, a set of programs from the channel 2930 are displayed. A video display 2940, enabled by a video player, is embedded within the interface. At the right of the interface 2900 are a plurality of controls that enable a user to a) customize the interface for a satellite device 2990, as previously described above with respect to the other interface embodiment, b) scale the interface footprint to the screen size of the satellite device 2950, such as the television, and c) hide a plurality of the controls 2960, such as the guide buttons 2920, 2930. Advertising, described above, is positioned at the bottom of the interface 2970 and a search bar is positioned at the left of the interface 2910.

It should be appreciated that each of the buttons or input dialog boxes are capable of receiving user input, whether in the form of a remote control, keyboard, mouse, touchpad, voice, or other input, processing the user input, and accessing the requested media or functionality. For example, where a specific channel 2930 is selected, programmatic code, or a plurality of computing instructions, direct networking software, the operating system, or other code responsible for accessing a network to the network location of the channel. Preferably, the channel makes its content available through a media feed that can be subscribed to, such as an RSS feed. That feed is then directed to the video player and displayed.

Mobile Phone Usage Example

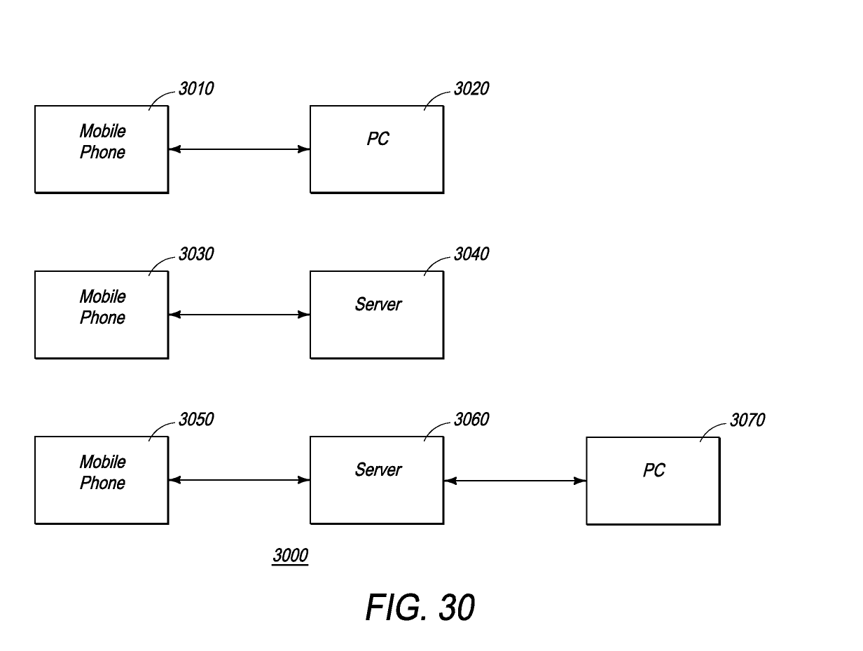

In one embodiment, a user uses a mobile phone as the satellite device to communicate, through an IP network, to a computing device. The computing device can be the user's own personal computer or a third party service provider's server that hosts the novel programs of the present invention. Referring to FIG. 30, three different configurations of the system are shown. A mobile phone 3010 can communicate directly with the user's own personal computer 3020. A mobile phone 3030 can communicate directly with a server hosted by a third party 3040. A mobile phone 3050 can communicate directly with a server hosted by a third party 3060 which, in turn, can be in communication with the user's own personal computer 3070.

The mobile phone (satellite device) may be any conventional mobile phone having a memory, an input mechanism for receiving commands from a user (keypad, touch screen, voice recognition, mouse), and a transceiver capable of wirelessly accessing an IP network, together with the novel program of the present invention stored therein. The personal computer or server (computing device) can also be any conventional personal computer or server having a memory and a transceiver capable of accessing an IP network, together with the novel program of the present invention stored therein.

A user wishing to access media stored in any storage location that is network accessible launches the program in the mobile phone, instructs it to connect to the personal computer or server, and further instructs it to access certain media. The media, which can include any form of data such as audio, graphics, text or video and can be any format, as described above, may be stored in any location that is local to the computing device or remote from computing device, provided it is network accessible. The interfaces described herein can be used to help users better devise the requisite instructions needed to direct the computing device to the desired media. The user's instructions to access certain media are communicated to the computing device.

The novel programs of the present invention, when executed on the computing device, receive and process the user commands and, according to the user commands, causes the computing device to access media, wherever it may be stored and causes the computing device to process the media. In accordance with the systems and methods described above, the program then captures the processed media, compresses the media, and causes the computing device to transmit the compressed media to the satellite device. The satellite device receives the compressed media, decompresses it and, if required, decodes it, and then renders the media on a display that is either integrated into the satellite device or in data communication therewith. It should be appreciated that the processed, coding, scaling, compression, and other data manipulation techniques can be optionally applied to the captured media prior to its transmission to the satellite device. The media access, media process, media compression, and media transmission all occur substantially in real-time and in response to the command instructions.

Where the computing device is a server hosted by a third party, multiple instances of the program can operate concurrently through multi-threading support, thereby enabling multiple users using multiple satellite devices to communicate with one server and use that one server to access, process, and transmit media to the multiple requesting satellite devices. In this embodiment, a user would first sign on to an account hosted by the server and tailor the hosted application to his or her own desires and tastes. The same interfaces as described herein, together with the tailoring options, can be provided in a hosted environment. Preferably, the account log-in would further obtain a user's mobile phone number. By having the user's mobile phone information and real-time knowledge of what media the user is accessing, the system can associate certain preferences, tastes, interests, favorites, media watching patterns, programs, genres, buying habits, viewing habits, and inclinations with a specific mobile phone number and user. In turn, the server can identify advertising that is uniquely tailored to the user and transmit it, along with the requested media, to the user. The system for matching advertising based upon preferences, tastes, interests, favorites, media watching patterns, programs, genres, buying habits, viewing habits, and inclinations is known in the art and can be done using any conventional programmatic method.

In another embodiment, a server operates to field command instructions from a mobile phone (satellite device) and communicates the instructions to the user's personal computer (the third embodiment shown in FIG. 30). The server then serves as a clearinghouse for receiving control data but does not perform the actual media access, processing, compression, and transmission. Those steps, and the requisite programs for doing so, are done by the personal computer. Again, the same interfaces as described herein, together with the tailoring options, can be provided in a hosted environment. Preferably, the account log-in would further obtain a user's mobile phone number.

This configuration has the benefit of not requiring a processing-intensive server farm and also has the benefit of enabling the server to obtain another piece of valuable data, namely the IP address of the user's computer, which can be used to further improve the development of, and association of, certain preferences, tastes, interests, favorites, media watching patterns, programs, genres, buying habits, viewing habits, and inclinations with a specific user, as identified by a mobile phone number and IP address. This data, if gathered by or communicated to the server, can help identify advertising that is uniquely tailored to the user and transmit it, along with the requested media, to the user, whether the user is using his satellite device or personal computer. The system for matching advertising based upon preferences, tastes, interests, favorites, media watching patterns, programs, genres, and inclinations is known in the art and can be done using any conventional programmatic method.

### User Remote Control Interactivity

To enhance the user experience and to make navigation and viewing of content on a satellite device, particularly a television, more user friendly, a two-dimensional remote control is provided in one embodiment of the present invention. Two-dimensional remote controls are known in the art and operate on the basis of optical triangulation techniques to judge where the remote signal is being directed. Examples of such remote control devices are Freespace™ remote by Hillcrest Labs™ and Wii™ remote by Nintendo™. Two dimensional remote controls are capable of sensing both the rotational orientation and translational acceleration along three dimensional axes, allowing them to determine where the remote is pointing. For two dimensional remote controls to work, a special receiver is incorporated on the receiving side of the satellite device. The special receiver may be plugged into or integrated within the satellite device. Thus with a two dimensional remote control, human motions with the handheld input device are precisely translated into on-screen cursor movements. The remote control can also transmit control commands such as a single click or a double click based upon the user pressing a button or two.

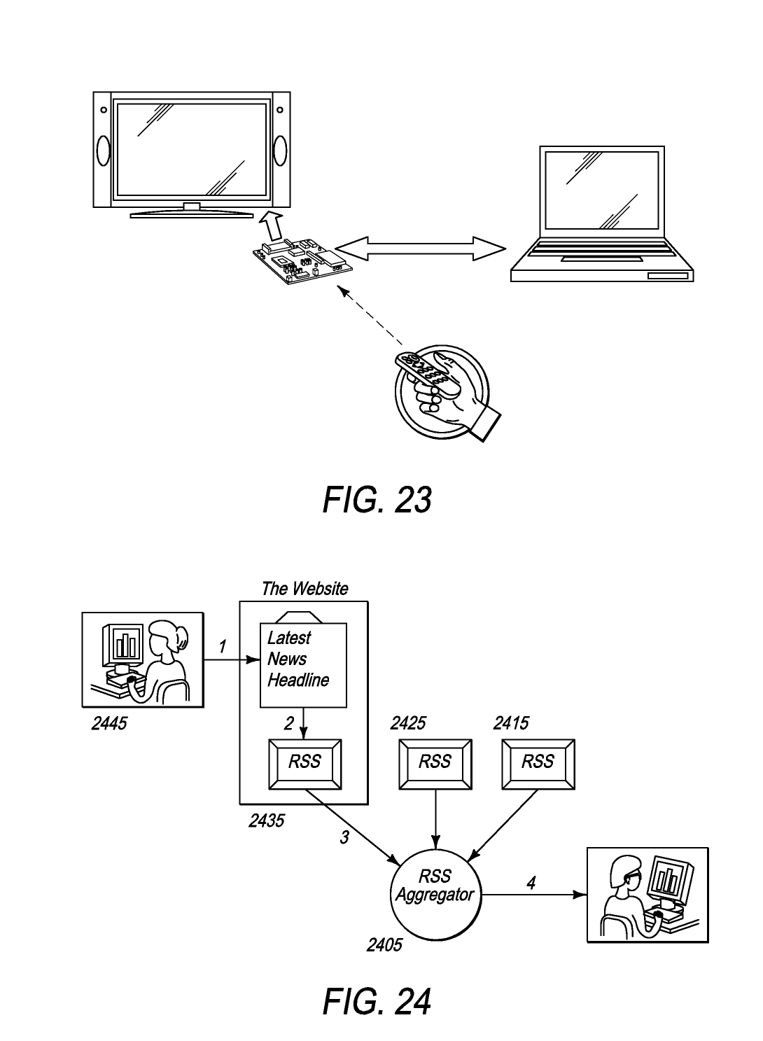

The use of a two dimensional remote control with the system of present invention is illustrated in FIG. 23. In this embodiment, a two dimensional remote control 2301 is provided, which is in communication with a remote control receiver 2302 at the television end. The remote control receiver 2302 is also in communication with a PC 2303, from where content is to be displayed on the television screen 2304. Thus, the remote control receiver 2302 receives the following data from the two dimensional remote control 2301, and communicates the same to the computing device 2303: a) data regarding where on the television screen the remote (or the user) is pointing and b) control data regarding which buttons the user is pressing and how.

This data is obtained by the software application of the present invention. The software application being executed on the computing device 2303 uses the data to determine what action to take depending on the cursor position presented by a user on the television screen. Thus the user is able to point to and click on specific links, icons or images. In one embodiment, an on-screen interface is also provided on the television that enables the users to type using a keyboard image.

To facilitate analogous navigation of PC content on a television using the two-dimensional remote control, the software application of the present invention relies on user input. As mentioned previously, before transmitting computer data for display on a television screen, the software application automatically scales the image to account for the difference in resolution and the screen size of a PC monitor and a television. Recognizing the scale of the TV image enables the software application of the present invention to accurately translate the two-dimensional remote control commands.

In another embodiment, a controller is used to route content from a computing device to a display that is remote from and, not in direct data communication with, the computing device. While the two dimensional remote control may be optimal for a user that is using his television as a display and his desktop computer as the computing device, a smart controller can be more universally used, and applied, to control the accessing, transmission, distribution, and reception of media from a remote computing device to a remote display.

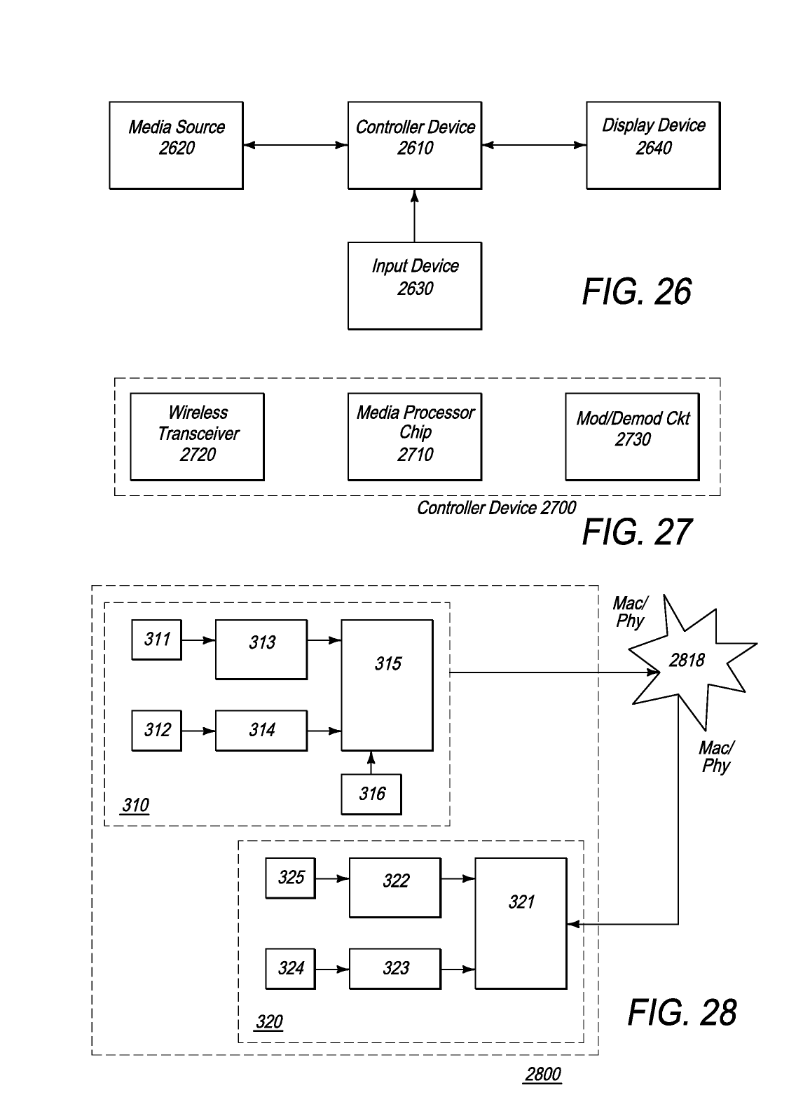

FIG. 26 illustrates the overall configuration of the system of present invention. Referring to FIG. 26, the system comprises a controller device 2610 that can receive media, including any video, graphics or audio media from a media source 2620. The media source may be any form of computing device, such as a computer, DVD player or recorder, set top box, satellite receiver, digital camera, video camera, mobile phone, or personal data assistant. The media source may also be any one of the servers accessible via the Internet, CDs, DVDs, other networks, or other storage devices. Also, the media source 2620 may be remotely located and accessed via any network, including an IP-compatible wireless network.

The controller device 2610 further receives command and other information from any type of input device 2630 such as a keyboard, keypad, touch screen pad, remote control, or mouse, and the information may be received through any wired or wireless network or by direct connection. Preferably, the input device is physically integrated with the controller device. The controller device 2610 can then process and transmit the commands and information from the input device 2630 to the media source 2620 to access, modify or affect the media being transmitted.

The controller device 2610 is capable of transmitting the media to any type of display device 2640, such as a monitor, a television screen, or a projector, or to any type of storage device or any other peripheral device. Each of the elements in FIG. 26 can be local or remote from each other and in data communication via wired or wireless networks or direct connects.

The device 2610 of the present invention therefore enables controllers, media sources, and displays to be completely separate and independent of each other. The device 2601 may optionally include a small screen, data storage, and other functionality conventionally found in a personal data assistant or cellular phone.

FIG. 27 is a block diagram illustrating the primary hardware components of the controller device of the present invention. The controller device 2700 comprises an integrated circuit, referred to as Media Processor chip 2710, which provides for unified processing of media of all types. Specifically, the chip 2710 supports both video type of codec for processing standard definition video with audio, including standards such as MPEG2/4, H.264, and others, as well as a lossless graphics codec for processing high definition video and graphics. The chip 2710 employs a novel protocol that distinguishes between different types of data streams. That is, the Media Processor chip 2710 is capable of distinguishing and managing each of the four components in a data stream: video, audio, graphics, and control. This allows the controller device 2700 to be used for accessing any graphic, video or audio information from a media source and have it displayed on any display. The controller device also allows a user to modify the coding type of the media from the media source and have it stored in a storage device which is remotely located and accessible via a wired or wireless network or direct connection. An exemplary chip is described in PCT/US2006/00622, which is also assigned to the owner of the present application, and incorporated herein by reference.

The controller device 2700 further comprises a wireless transceiver 2720 that enables it to wirelessly receive data from a media source and transmit the received data wirelessly to the display or other output peripheral device. One of ordinary skill in the art would appreciate that the wireless transceiver 2720 may operative to communicate in accordance with any one of the prevalent wireless specification standards, such as IEEE 802.11(Wi-Fi), Bluetooth, Home RF, Infrared (IrDA), or Wireless Application Protocol (WAP).

The controller device 2700 also comprises a modulator/demodulator circuit 230 for processing video, audio and graphics into a form suitable for routing the data from the media source to the display. Processing functions carried out by the circuit 2730 may include frequency translation, and/or conversion of digital signals into or recovering them from quasi-analog signals suitable for transmission.

FIG. 28 illustrates an exemplary architecture for the integrated Media Processor chip that is used with the controller device of the present invention. Referring to FIG. 28, the integrated Media Processor chip 2800 comprises two processing devices 310 and 320. The processing devices 310 and 320 can be hardware modules or software subroutines, but, in the preferred embodiment, both the devices are incorporated into the single integrated chip 2800. The integrated chip 2800 is used as part of a data storage or data transmission system.

The first processing device 310 is in communication with a media source (not shown), which transmits graphic, text, video, and/or audio data to the processing device 310. The processing device 310 further comprises a plurality of media pre-processing units 311, 312, a video and graphics encoder 313, an audio encoder 314, a multiplexer 315 and control unit 316. All these components are collectively integrated into the processing device 310.

Data from the media source is received at the preprocessing units 311, 312 where it is processed and transferred to the video and graphics encoder 313 and audio encoder 314. The video and graphics encoder 313 and audio encoder 314 perform the compression or encoding operations on the preprocessed multimedia data. The two encoders 313, 314 are further connected to the multiplexer 315 with a control circuit in data communication thereto to enable the functionality of the multiplexer 315. The multiplexer 315 combines the encoded data from video and graphics encoder 313 and audio encoder 314 to form a single data stream. This allows multiple data streams to be carried from one place to another over a physical or a MAC layer of any appropriate network 2818.

For rendering the media suitable for display, the integrated chip employs a second processing device 320. The second processing device 320 further comprises, collectively integrated into it a demultiplexer 321, video and graphics decoder 322, audio decoder 323 and a plurality of post processing units 324, 325. The data present on the network 2818 is received by the demultiplexer 321 that resolves the high data rate streams into original lower rate streams and converts the data stream into the original multiple streams. The multiple streams are now passed to different decoders i.e. video and graphics decoder 322 and audio decoder 323. The respective decoders decompresses the compressed video and graphics and audio data in accordance with appropriate decompression algorithm, preferably LZ77 and supply them to the post processing units 324, 325 that make the decompressed data ready for display and/or further rendering on an output device.

Besides being used with the controller device for routing the data from a media source to a display, the integrated media processor chip of the present invention may also be provided at the media source itself. In that case, the data is processed directly at the source for transmission to any display device, that is, data processing at the controller is not required. Further, the integrated Media Processor chip is also provided at the display or any other output device, where it receives the data and processes it into a format suitable for display. In each of the media source and display, the integrated Media Processor chip can either be integrated into the device or externally connected via a port, such as a USB port.

Thus, the system of the present invention allows USB interfaces to be used to transmit video, audio, graphics and other data. Further, the present system is also capable of supporting real time as well as non real time transmission, i.e., the encoded stream can be stored for future display or could be streamed over any type of network for real time streaming or non streaming applications. Through this innovative approach, a number of applications can be enabled. For example, monitors, projectors, video cameras, set top boxes, computers, digital video recorders, and televisions need only have a USB connector without having any additional requirement for other audio or video ports. Multimedia systems can be improved by integrated graphics or text intensive video with standard video, as opposed to relying on graphic overlays, thereby enabling USB to TV and USB to computer applications and/or Internet Protocol (IP) to TV and IP to computer applications.

The controller device of the present invention can be used to remotely direct the access and transfer of data from a wireless Internet access point to a display device such as a television. The controller device, which is equipped with a wireless transceiver, connects to a wireless access point. The wireless access point is in turn connected to another wired or wireless network through a router, and through that network, to the Internet. Thus, the controller device has access to the content from internet. As previously mentioned, the controller device is capable of accepting inputs from a standard input device such as a keyboard or a mouse. Further, the controller itself may also include the functionality of an input device, besides including a small screen, data storage, and other functionality conventionally found in a personal data assistant or cellular phone.

Thus, when the controller is connected to the Internet, a user can use the controller device to access any desired web pages. Further, since the specialized media processor chip of the present invention allows the controller to route any type of media to a display, the user can utilize the controller to direct the content obtained from the Internet to a display device, such as a television screen or a computer monitor. Thus, a user can achieve the experience of Internet surfing on a television screen, without using a conventional computer system.

In a first embodiment, the controller device is a cell phone or cell-phone enabled personal data assistant. In a second embodiment, the controller device is a handheld apparatus such as a remote control, which provides portability and convenience of use. Further, in order to provide a convenient user interface for making the browsing experience user-friendly, the controller device may be provided with a browsing program, similar to conventional browsers such as Internet Explorer™ used in computer systems. Alternatively, the controller device may be equipped with a limited menu browser that can be programmed to go to certain sites or perform certain functions. This option allows for a more simplified operation of the controller device. In one embodiment, the controller device may be connected to a PC and, using a website-based application or client application, a user may customize the browsing functionality of the controller device according to his or her needs. Thus, for example, the controller device may be provided with a single dial or scroll buttons that enable a user to scroll through a pre-established list of websites. The user can select a particular website using another push button. Once at the website (which the controller would recognize), the controller may present the user a menu of web pages specific to that website. For example, if the selected website is a portal such as Yahoo!, the controller may present the user with a menu of links that allow the user to check mail, obtain stock quotes, weather information, etc.

With the use of a limited menu browser program, inputting text data into the controller is minimized. However, the functionality of text input may still be provided in the controller, either in a limited manner such as through use of scroll buttons and keypad as in a mobile phone, or in a more expansive manner as is provided in a PDA by using a stylus.

In one embodiment, the controller may be provided with a programmable menu for enhanced user experience. Such a menu may offer options such as setting of a timer function that enables switching on or off at a particular time the display from a given media source. This function may further be supplemented with the provision of features such as parental control and child lock. Thus, a menu may enable the user to program the controller to block certain sites from the Internet or certain types of content to be displayed. Conversely, the controller may be programmed to allow display only from a limited number of specified Internet sites or only from a particular set of media sources.

In another embodiment, the controller functions may be personalized to suit the needs of the user. Thus, the controller enables the user to select a specific site or “home page”, which is automatically displayed as soon as a connection with the Internet is established. The controller may further offer options such as alerting the user every time some specific content is updated or when any new content is available on the sites specified by the user.

The controller may be customized to allow users to schedule Internet surfing at their desired timings. Thus, for example if a user wants stock updates from a particular website every Monday morning at 10.00 a.m., he or she can program the controller to automatically connect to the Internet at that time and have the desired content displayed automatically on a television screen. Conversely, the controller may also be programmed to block content from certain sites or even certain media sources to be displayed after a definite time of the day. Thus, for example, as a part of the parental control features, the controller may allow a user to disable access of content from specified media sources after 10.00 p.m.

Further, when a user customizes the controller to automatically display certain content at specific timings, then the controller may also notify the user that the display of their chosen content is about to begin prior to the scheduled time. The timing for receiving such an alert before the display begins may be predetermined by the user, such as 10 minutes before the content display begins. Additionally, periodic reminders may be set. The alerts may be audio or visual or both, such as, but not limited to, an audible beep or an LED flashing on the controller, an auto display on a pre-selected display device, etc.

Optionally, the controller may provide functionality completely customized according to a specific website or a portal such as Google that acts as a content provider or media source. In this case, a user may optionally program the remote control functionality through the content provider's website by using a wired or wireless connection to the Internet. As soon as the controller device establishes a connection to the Internet, it opens a browser window that automatically redirects to the user's remote control programming page, where the user may customize the features for accessing content according to his or her preferences. Optionally, a password or other authentication feature may be built in by the content provider for allowing a user to customize the controller functionality. Further optionally, the user may have a subscription to the content provider service.

The ability to personalize the controller for displaying content according to a user's preferences may be further leveraged in a scenario wherein cable and broadband services are integrated such that television programs that are currently broadcast mainly via cable are also available via the Internet. In that case, a user may program the controller to access his or her favorite channels at predetermined time schedules. Further, the user may also program the controller to notify the user when a favorite program is on. Scheduling and setting alerts for chosen programs may be done online via the web interface of the content provider. In one embodiment, the controller may be programmed to access only that content which the user has subscribed to. Thus, if a user has not subscribed to a particular channel, the controller may be programmed to skip over those particular content avenues.

In another embodiment, the controller may be programmed to communicate with a Digital Video Recorder (DVR) or a Personal Video Recorder, so that the user is able to not only schedule the display of desired Internet content at the desired time on a television screen, but is also able to have the content recorded by the DVR for later viewing. Optionally, the features offered by a regular DVR remote control, such as controlling (pause, forward, rewind etc) live television, scheduling from a program guide, searching for programs to record, etc, may be incorporated into the controller device of the present invention itself. In this embodiment, the controller acts as a hybrid remote control that directs viewing of Internet content on television and also provides personalization and other features to control access to regular TV programs.

Optionally, the controller may also provide the user with enhanced security and privacy features such as setting up of a password for allowing display. Further, different passwords may be set for different types of media sources. Further optionally, the controller may be equipped with an operating software that allows full access and programming rights to one user, who may be termed as an administrator, and limited access rights to other users. A provision of complete barring of access for unauthorized users may also be made available with the controller.

As mentioned previously, in one embodiment, the controller device is a handheld apparatus, which provides portability and convenience of use. In one embodiment, the controller device is a cell phone. In this case, the mobile phone is equipped with the specialized media processor chip of the present invention. This enables the mobile phone to connect wirelessly to an access point, and from there to the Internet, or to any other source of media such as a PC or a laptop, which has the capability of transmitting data wirelessly. Alternatively, the content may be received into the cell phone over any network that the cell phone is capable of supporting. The cell phone can then be used to wirelessly direct the received media to any display device, which has the specialized media processor chip, that can receive the signal at the display and decode that signal for viewing. One of ordinary skill in the art would appreciate that the control and content signals may be transported to the display from the cell phone via any networking technology such as cellular, Bluetooth, or Wi-Fi. For this purpose, the required software may be downloaded or preloaded onto the mobile device. Also, instead of being directly routed, the signal may be first conditioned into a suitable format for display at the cell phone itself and then routed to the display device such as a television.

Besides its usual keypad, a cell phone that is to be used as a controller may include additional user operable buttons that allow a user to control the transmission of media from the source to the display and switch between modes and configurations. Optionally, any other input device such as a keyboard, a mouse or a remote may be used in conjunction with the cell phone.

Further, several features already available in a mobile phone may be utilized when the phone is being used as a controller. For example, most cell phones are equipped with speed dialing facility. The same feature may be configured to automatically access a particular web page as soon as the cell phone connects to the internet through a wireless access point. Similarly, many cell phones are provided with a “favorites” function that allows a user to setup quick shortcuts to frequently dialed numbers, groups of contacts, device applications, e-mails and web links. This function may be utilized when the cell phone is used as a controller, to set favorite web pages that are accessed by the cell phone and displayed on an external device at the click of a button.

Further, many cell phones are also provided with voice recognition capability. This feature can be used to recognize user commands for directing the display of content through the cell phone.

Since a user may schedule the display of specific content online via the web interface of the content provider, he or she may be reminded at chosen display timings or notified about availability of new content by means of text messages on the cell phone being used as a controller.

One of ordinary skill in the art would appreciate that besides employing a cell phone for controlling the display of media from an external source, the content available in the cell phone itself may also be output on any suitable peripheral device. Thus, short messages (SMS) may be written or read using a computer monitor, multimedia messages may be played on a television screen and so on. Most new generation cell phones are equipped with in-built still and motion cameras, and the pictures or videos captured through the same may be directly viewed on a television, a laptop or through a projector, without requiring the content to be first downloaded onto a computer or copied into a storage device. Similarly, any audio content in the cell phone may also be routed to and played on an external audio system equipped with the specialized media processor chip of the present invention. Thus, users who use cell phones provided with FM radios or MP3 players, may utilize this feature to experience music on audio systems that offer better sound quality.

Further, the present invention also allows users to directly connect to the Internet and upload, download, share and send the photos, videos and audio files from their phones to friends and family, without using a computer.

Since most mobile phones are themselves capable of downloading e-mails and other content from the internet, therefore, with the system of present invention, any such downloaded content may be viewed on an external display, thereby eliminating the drawback of small screens in mobile phones. Since new generation cell phones also support reception of streaming audio and video from a network, the streamed content may also be viewed and/or heard simultaneously, in real time, on external devices.

The ability to use any display for viewing the content in a cell phone is even more advantageous when applied to mobile gaming. As most users enjoy playing games on their cell phones, overcoming the limitation of small screens may allow cell phone manufacturers to offer more advanced gaming features on the phone, which was hitherto possible only with games that can be played using a computer monitor or television screen. In one embodiment, a cell phone programmed as a controller may be enabled to access real-time video games, such as those played by multiple users via the Internet (online gaming services). At the same time, the cell phone may also be programmed to function as a game controller, that is, a user may program the cell-phone controller, via an interface, to act as a “gaming control” to access interactive gaming content on the Internet.

In another embodiment, a Personal Data Assistant (PDA) is used as a controller for routing content from a source to a display. The source of content may be the Internet, to which the PDA may be connected wirelessly, such as through a wireless access point, or through any other wired means. Alternatively, the source of content may be other networks or storage devices such as, but not limited to, CDs and DVDs.

When used with the specialized media processor of present invention, a PDA may be used not only for reading and writing e-mails and browsing the web on an external display device with a larger screen, but also for working with applications such as word processing, spreadsheets and making presentations. The latter feature enhances a user's convenience of using a PDA, without compromising on the portability of the computing device.

With the system of present invention, any media experience, which is limited when a PDA is used alone, is enhanced by directing the media to appropriate external peripheral device. Thus, media experiences such as viewing photos and videos, reading e-books, and listening to music are all improved by several notches even though all the media is sourced through a PDA. Further, since the system of present invention also supports routing of media in real time, any content streaming on the PDA from a network may also be displayed simultaneously on another device.

Aside from routing content from a source to a display, the present invention also enables other user applications that, to date, have not been feasible. In one embodiment, the present invention enables the wireless networking of a plurality of devices in the home without requiring a distribution device or router. A device comprising the integrated chip of the present with a wireless transceiver is attached to a port in each of the devices, such as set top box, monitor, hard disk, television, computer, digital video recorder, gaming device (Xbox, Nintendo, Playstation), and is controllable using a control device, such as a remote control, cell phone, PDA, infrared controller, keyboard, or mouse.

Video, graphics, and audio can be routed from any one device to any other device using the controller device. The controller device can also be used to input data into any of the networked devices.

Therefore, a single monitor can be networked to a plurality of different devices, including a computer, digital video recorder, set top box, hard disk drive, or other data source. A single projector can be networked to a plurality of different devices, including a computer, digital video recorder, set top box, hard disk drive, or other data source. A single television can be networked to a plurality of different devices, including a computer, set top box, digital video recorder, hard disk drive, or other data source. Additionally, a single controller can be used to control a plurality of televisions, monitors, projectors, computers, digital video recorders, set top boxes, hard disk drives, or other data sources. A single controller device may be therefore used to manage a single display device, as described in previous embodiments, or it may be used to direct multiple displays. Conversely, the system of the present invention also allows for wireless networking of multiple display devices, wherein each device may be managed by a separate controller device.

The above examples are merely illustrative of the many applications of the system of present invention. Although a few embodiments of the present invention have been described herein, it should be understood that the present invention might be embodied in many other specific forms without departing from the spirit or scope of the invention. For example, other configurations of transmitter, network and receiver could be used while staying within the scope and intent of the present invention. Further, one of ordinary skill in the art would appreciate that the software applications features, functions, and user interfaces are generated by providing an instruction set which directs hardware and operating system elements to perform the above described functions. Therefore, the present examples and embodiments are to be considered as illustrative and not restrictive, and the invention is not to be limited to the details given herein, but may be modified within the scope of the appended claims.

We claim:

1. In a media transmission and reception system with a satellite device having a memory, an input mechanism for receiving commands from a user, and a transceiver capable of wirelessly accessing an IP network, and with a computing device having a memory and a transceiver capable of accessing an IP network, programs comprising:
a. a plurality of routines stored in the memory of said satellite device wherein said routines, when executed by a processor of said satellite device, causes the commands to be processed, causes the satellite device to connect to the computing device through said IP network, and causes the satellite device to transmit command instructions, derived from said commands, to said computing device through said IP network; and
b. a plurality of routines stored in the memory of said computing device wherein said routines, when executed by a processor of said computing device, causes the computing device to access media stored in a memory, causes the computing device to process said media, captures said processed media, compresses said media, and causes the computing device to transmit said compressed media to the satellite device, wherein said media access, media processing, media compression, and media transmission occurs in real-time and response to said command instructions.

2. The programs of claim 1 wherein said satellite device is at least one of a cellular phone or personal data assistant.

3. The programs of claim 2 wherein said computing device is at least one of a personal computer, server, or laptop.

4. The programs of claim 1 wherein said memory storing the media is remote from the computing device.

5. The programs of claim 4 wherein the computing device access the media stored in the memory through the IP network.

6. The programs of claim 1 wherein the plurality of routines stored in the memory of said computing device captures said processed media, wherein said media comprises at least audio data and video data, by capturing said video data from a mirror display driver and by capturing said audio data from an input source.

7. The programs of claim 1 wherein the plurality of routines stored in the memory of said computing device captures said processed media, wherein said media comprises at least audio data and video data, by capturing said video data from a buffer after said video data has been processed and prior to said processed video data being rendered to a display.

8. The programs of claim 1 wherein the programs further comprise a routine stored in the memory of said computing device wherein said routine, when executed by a processor of said computing device, encodes said media after said media has been processed and captured and before said media is transmitted to the satellite device.

9. The programs of claim 8 wherein the programs further comprise a routine stored in the memory of said satellite device wherein said routine, when executed by a processor of said computing device, decodes said media after said media has been received from said computing device.

10. The programs of claim 1 wherein the plurality of routines stored in the memory of said computing device causes the computing device to transmit said compressed media, wherein said media comprises at least video data, to the satellite device by establishing a connection with the satellite device using TCP and transmitting packets of video data using UDP.

11. The programs of claim 1 wherein the plurality of routines stored in the memory of said computing device, when executed by a processor of said computing device, applies a CODEC to the media, wherein the media at least has video data, that has been captured and processed by the computing device.

12. The programs of claim 11 wherein said CODEC removes temporal redundancy from said video data using motion estimation.

13. The programs of claim 11 wherein said CODEC converts a frame of video data into x*y blocks of pixels using a DCT block, wherein x is equal to y.

14. The programs of claim 11 wherein said CODEC codes video data into shorter words using a VLC coding circuit.

15. The programs of claim 11 wherein said CODEC converts back spatial frequencies of the video data into the pixel domain using an IDCT block.

16. The programs of claim 11 wherein said CODEC comprises a rate control mechanism for speeding up the transmission of media.

17. A method for accessing and transmitting media between a computing device having a memory and a transceiver capable of accessing a network and a satellite device having a memory, an input mechanism for receiving commands from a user, and a transceiver capable of wirelessly accessing a network, the method comprising the steps of:
a. providing a program that is stored in the memory of said satellite device wherein said program, when executed by a processor of said satellite device, causes the commands to be processed, causes the satellite device to connect to the computing device through said network, and causes the satellite device to transmit command instructions, derived from said commands, to said computing device through said network; and
b. providing a program that is stored in the memory of said computing device wherein said program, when executed by a processor of said computing device, causes the computing device to access media stored in a memory, causes the computing device to process said media, captures said processed media, compresses said media, and causes the computing device to transmit said compressed media to the satellite device, wherein said media access, media processing, media compression, and media transmission occurs in real-time and response to said command instructions.

18. The method of claim 17 wherein the program stored in the memory of said computing device captures said processed media, wherein said media comprises at least audio data and video data, by capturing said video data from a mirror display driver and by capturing said audio data from an input source.

19. The method of claim 17 wherein the program stored in the memory of said computing device captures said processed media, wherein said media comprises at least audio data and video data, by capturing said video data from a buffer after said video data has been processed and prior to said processed video data being rendered to a display.

20. The method of claim 17 wherein the program stored in the memory of said computing device, when executed by a processor of said computing device, applies a CODEC to the media, wherein the media at least has video data, that has been captured and processed by the computing device.

21. The method of claim 20 wherein said CODEC removes temporal redundancy from said video data using motion estimation.

22. The programs of claim 21 wherein said CODEC converts a frame of video data into x*y blocks of pixels using a DCT block, wherein x is equal to y.

23. The programs of claim 22 wherein said CODEC codes video data into shorter words using a VLC coding circuit.

24. The programs of claim 23 wherein said CODEC converts back spatial frequencies of the video data into the pixel domain using an IDCT block.
